(19) United States
(12) Patent Application Publication
(10) Pub. No.: US 2009/0271264 A1
(43) Pub. Date: Oct. 29, 2009

(54) PROMOTIONAL TECHNIQUES, SYSTEMS AND METHODS

(75) Inventors: Manoj Regmi, Castle Rock, CO (US); Jeffrey A. Simon, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IGCSystems, Inc., Castle Rock, CO (US)

(21) Appl. No.: 12/429,879

(22) Filed: Apr. 24, 2009

Related U.S. Application Data
(60) Provisional application No. 61/047,749, filed on Apr. 24, 2008.
(60) Provisional application No. 61/115,237, filed on Nov. 17, 2008.
(60) Provisional application No. 61/167,391, filed on Apr. 7, 2009.

(51) Int. Cl. G06Q 30/00

(52) U.S. Cl. 705/14.23; 705/14.56; 705/14.25; 705/14.39; 705/14.55

(57) ABSTRACT

Tools for improving interactions between promoters and consumers of products. These tools can enable promoters of products to employ more effective promotional programs, and consumers to receive promotional information about products of interest, while avoiding the excessive overload of information about promotions that are not of interest. Some such tools can enhance consumer satisfaction with—and, correspondingly, consumer participation in—promotional programs by allowing consumers to tailor the discount programs to their preferences, by analyzing consumer behavior and tailoring promotions accordingly, and/or by providing cross promotions of complementary products. Some of the tools can provide substantial savings, in both costs and natural resources, as well as provide a more satisfying experience for consumers, by substantially reducing, or even eliminating, excessive use of paper for promotional programs and transaction receipts.

### CROSS-REFERENCE TO RELATED APPLICATIONS

This application claims the benefit, under 35 U.S.C. § 119(e), of the following provisional applications, the entire disclosures of which are incorporated herein by reference for all purposes: U.S. Prov. App. No. 61/047,749, filed Apr. 24, 2008 by Regmi et al. and entitled “Promotional Techniques, Systems and Methods”; U.S. Prov. App. No. 61/115,237, filed Nov. 17, 2008 by Regmi et al. and entitled “Promotional Techniques, Systems and Methods”; and U.S. Prov. App. No. 61/167,391, filed Apr. 7, 2009 by Regmi et al. and entitled “Promotional Techniques, Systems and Methods.”

This application may also be related to the following commonly-assigned, co-pending applications, each of which was filed on a date even herewith by Regmi et al.: U.S. patent application Ser. No. ______, entitled “Managing Lists of Promotional Offers” (attorney docket no. 027405-000120US); U.S. patent application Ser. No. ______, entitled “Promotional Programs with Electronic Receipts” (attorney docket no. 027405-000130US); U.S. patent application Ser. No. ______, entitled “Cross-Promotional Techniques, Systems, and Methods” (attorney docket no. 027405-000140US); and U.S. patent application Ser. No. ______, entitled “Employing Consumer Intelligence in Promotions” (attorney docket no. 027405-000150US). The entire disclosure of each of these applications is incorporated herein by reference for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to promotional programs and more particularly, to tools for enhancing consumer satisfaction with, and/or participation in, such promotional programs.

### BACKGROUND

Merchants continually seek more effective and efficient ways to communicate with potential customers. In the past, tools like coupon circulars, flyers, advertising inserts, and the like have been used, with varying degrees of success. One problem with these techniques is that they are generally quite unfocused, relying on a scattershot approach in which many advertisements are distributed with the hope of reaching a few interested customers. Such techniques consume an incredible amount of natural resources annually, resulting in needless harm to the environment. Moreover, the scattershot nature of such techniques is as likely to annoy a consumer who receives many such advertisements every day and might discard them without reading them, as it is to attract a potential consumer who might be interested in the advertised product but who overlooks the advertisement because it is lost in the shuffle with many other advertisements or who is turned off by the advertising method.

Accordingly, it would be beneficial to have more intelligent tools and techniques for providing promotions and advertisements to consumers.

### BRIEF SUMMARY

Certain embodiments provide tools for enhancing consumer satisfaction with—and, correspondingly, consumer participation in—promotional programs, such as discount programs (e.g., coupons), promotional advertising, and the like, by allowing consumers to tailor the discount programs to their preferences. In another aspect, particular embodiments can provide substantial savings, in both cost and natural resources, as well as provide a more satisfying experience for consumers, by substantially reducing, or even eliminating, excessive use of paper for promotional programs and transaction receipts. In yet another aspect, a set of embodiments can allow promoters of various products to obtain meaningful metrics on the efficacy of varying promotional strategies, and/or to employ advanced promotional strategies, including without limitation, customer intelligence, cross-promotions, and the like.

The tools provided by various embodiments of the invention include, without limitation, methods, systems, and/or software products. Mainly by way of example, a method might comprise one or more procedures, any or all of which are executed by a computer system. Correspondingly, an embodiment might provide a computer system configured with instructions to perform one or more procedures in accordance with methods provided by various embodiments. Similarly, an apparatus might comprise a computer readable storage medium having encoded there on a computer program, which might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a system that can be used to manage promotional programs, in accordance with various embodiments.

FIG. 2 is a process flow diagram illustrating a method of providing a promotional program, in accordance with various embodiments.

FIG. 3 is a process flow diagram illustrating a method of providing electronic receipts, in accordance with various embodiments.

FIG. 4 is a generalized schematic diagram illustrating a computer system, in accordance with various embodiments.

FIG. 5 is a block diagram illustrating a networked system of computers, which can be used in accordance with various embodiments.

FIG. 6 is a process flow diagram illustrating a method of providing a consumer with promotional information, in accordance with various embodiments.

FIGS. 7-17 are screen displays from an exemplary consumer user interface, in accordance with various embodiments.

FIG. 18 is a process flow diagram illustrating a method of facilitating the distribution of promotional information for a merchant, in accordance with various embodiments.

FIGS. 19-26 are screen displays from an exemplary retailer user interface, in accordance with various embodiments.

FIGS. 27-29 are process flow diagrams illustrating various methods that can be used to provide cross-promotional services, in accordance with various embodiments.

### DETAILED DESCRIPTION

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In an aspect, certain embodiments provide novel tools for improving interactions between promoters and consumers of products. (The term “product” is used broadly herein to connote any good, service, etc. that can be sold or purchased, and the terms “promoter,” “retailer,” and “merchant” are used broadly herein to refer to any entity that is involved in the production, distribution, sale, marketing, advertising, etc. of a product.) In various embodiments, these tools can enable promoters of products to employ more effective promotional programs, and consumers to receive promotional information about products of interest, while avoiding the excessive overload of information about promotions that are not of interest.

By way of example, certain embodiments provide tools for enhancing consumer satisfaction with—and, correspondingly, consumer participation in—promotional programs, such as discount programs (e.g., coupons), promotional advertising, and the like, by allowing consumers to tailor the discount programs to their preferences. In another aspect, particular embodiments can provide substantial savings, in both costs and natural resources, as well as provide a more satisfying experience for consumers, by substantially reducing, or even eliminating, excessive use of paper for promotional programs and transaction receipts. In yet another aspect, a set of embodiments can allow promoters of various products to obtain meaningful metrics on the efficacy of varying promotional strategies and/or to employ cross-promotional strategies to enhance consumer interest in the promoted products.

In a beneficial aspect, tools provided by certain embodiments can allow a consumer to obtain a single discount card (which may be a physical card or simply a virtual card, which might comprise an identifier for the consumer, as described in further detail herein) that can be used to obtain discounts from multiple merchants, retailers and/or product promoters. In some embodiments, these retailers/promoters need have no relationship with one another, other than that they participate in one or more promotional programs provided by various embodiments. In other embodiments, two or more merchants might have a cross-promotional relationship, and certain embodiments can facilitate such a relationship. Beneficially, various embodiments can allow a consumer to obtain discounts and/or other benefits, as described herein from any participating retailer, without having to carry or remember a separate set of credentials for each retailer. As another example, certain embodiments will allow a single card/identifier to be issued to an organization (or other collection of consumers), and each consumer in the organization then can obtain the benefits provided by the promotional tools described herein.

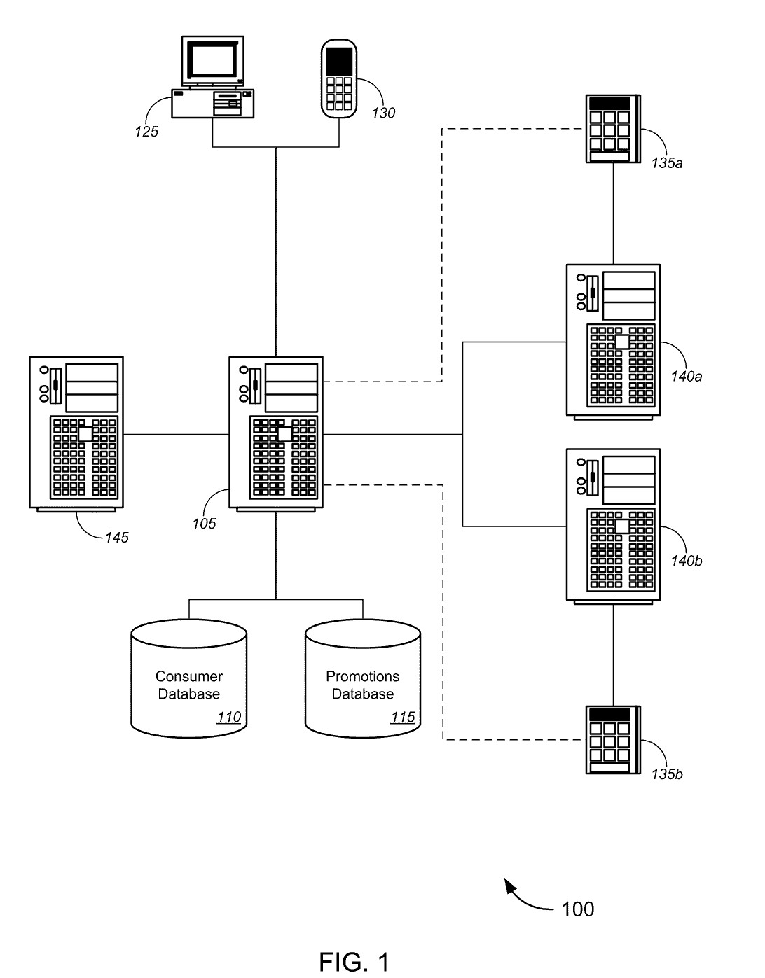

FIG. 1 illustrates a system 100, in accordance with one set of embodiments. The system 100 comprises a computer system 105, which is configured (e.g., with appropriate software, firmware, etc.) to function in accordance with various embodiments, including without limitation procedures in accordance with the methods described below. In a particular embodiment, the computer system 105 is a mainframe computer or other server computer that is configured to perform transaction-processing applications (commonly referred to in the art as a “host” computer).

In the system 100 of FIG. 1, the computer system 105 comprises (or is otherwise in communication with) a consumer database 110 and/or a promotions database 115. Although the term “database” is used herein for ease of description, that term should be construed broadly to mean any type of data store in which data may be stored, maintained, accessed and/or modified, including without limitation relational databases, “flat” databases, file systems, and/or the like. It should also be noted that, while the consumer database 110 and promotions database 115 are described herein for exemplary purposes, the arrangement of data within and between those two databases is provided only to illustrate the inventive concepts of one set of embodiments—other data arrangements, which might arrange data differently among the consumer database 110 and promotions database 115, consolidate those two databases, and/or employ additional databases to store some or all of this data, are possible within the scope of other embodiments.

Hence, in an embodiment, the consumer database 110 stores consumer profiles for each of a plurality of consumers. In an aspect, as described in further detail below, each of the consumers may have indicated a willingness to participate in promotional programs, and a consumer profile for a particular consumer therefore might comprise data about that consumer that is relevant to one or more promotional programs. Such data can include, without limitation, biographical data (e.g., name, address, email address, phone number, credit card data, etc.), preference data (e.g., data regarding products about which the consumer would like promotional information, data regarding preferred modes of notification for promotional programs, data regarding preferences for electronic receipts vs. paper receipts, etc.), transaction data (e.g., data about past transactions, such as promotions offered to the consumer, promotions accepted, products purchased through promotions; data about the circumstances of a transaction, such as location of purchase, amount of purchase, discounts applied to purchase, timing of purchase in relation to promotional program, etc.), and/or the like. (It should be noted that some of this data, such as transaction data to name one example, may be stored in a separate database).

In another embodiment, the promotions database 115 stores promotional data about promotions being offered via the computer system 105. This promotional data can include, inter alia, promotional materials themselves (e.g., electronic coupons, promotional advertisements, and/or the like) as well as metadata about the promotions (e.g., coding information about a product or products to which each promotion pertains, term data about a term of the promotion, data about consumers to whom the promotions have been sent, and/or the like), as well as other promotion-specific data.

Together, the consumer database 110 and the promotions database 115 (along with any other appropriate databases, such as merchant databases that comprise profiles of various merchants participating in and/or offering promotional programs) provide the computer system 105 with the data necessary to determine (as indicated below, for example) which promotions a particular consumer might be interested in, as well as to provide electronic receipts of transactions (if a consumer so desires) and/or to allow a promoter to analyze the effectiveness of various promotions, engage in cross-promotions, and/or the like.

The computer system 105 is configured to be in communication with one or more user devices (also referred to herein as “consumer devices” when described in the context of communications with a consumer), in order (for example) to notify the consumer of promotional offers, to receive information (such as promotional program enrollment information, consumer profile data, preference data, etc.) from the consumer, to provide reports and/or electronic receipts to the consumer, and/or the like. Similarly, user devices can be used to send information to and/or receive information from merchants and other participants in promotional programs.

For ease of illustration, FIG. 1 depicts only two user devices: a client computer 125 and a wireless device 130). Various embodiments, however, can support any of a variety of user devices, including without limitation personal computers, laptop computers, facsimile machines, personal digital assistants (“PDA”) (which may or may not have wireless phone capabilities and/or other wireless communication capabilities), wireless (e.g., CDMA, GSM, etc.) telephones, traditional (“POTS”) telephones, WiFi or WiMAX enabled devices, electronic wallets, electronic books, and/or the like. Virtually any device that may be operated by a user and that has communication capabilities (wired, wireless, etc.) can be supported by various embodiments.

In order to provide communication with a wide variety of user devices, the computer system 105 may be configured to communicate via several different techniques, as appropriate for the capabilities of the respective consumer devices, the communication needs of the system 100 and/or the communication preferences of the user.

Merely by way of example, in some embodiments, the computer system 105 may be configured to communicate with a client computer 125 via a dedicated application running on the client computer 125, which provides a user interface for a consumer or a merchant (and/or an employee or agent thereof) to interact with the computer system 125. In other embodiments, however, the user interface may be provided from a web site, e.g., by providing a set of one or more web pages, which may be displayed in a web browser running on the client computer 125 and/or served by a web server (not shown on FIG. 1). Merely by way of example, the computer system 105 might comprise the web server and/or be in communication with the web server, such that the computer system 105 provides data to the web server to be served as web pages for display by a browser at the client computer 105. In other cases, the computer system 105 and/or the web server may be configured to provide the user interface by transmit data for reception by a mobile device, such that components of the user interface can be displayed on the mobile device; merely by way of example, data may be transmitted as web pages formatted in accordance with the wireless application protocol (“WAP”) and/or the like for reception by a Web-enabled wireless phone.

Alternatively and/or additionally, the computer system 105 may be configured with a facility for sending and receiving electronic mail (“e-mail”), such as an SMTP server. (In some embodiments, the computer system 105 may not comprise the e-mail facilities but may instead be in communication with a separate computer (not shown on FIG. 1) that provides such facilities.) In this way, if desired by the consumer, the computer system 105 can communicate with a consumer or merchant via e-mail, which can be sent for reception by any appropriate consumer device, including without limitation a client computer 125, a wireless device 130, etc.

Depending on the capabilities of various user devices that may be employed, the computer system 105 may be configured to provide other types of communication with consumers (or merchants, etc.) as well. Merely by way of example, the computer system 105 may be configured to communicate by transmitting a short message service (“SMS”) message, a multimedia message service (“MMS”) message, etc. for receipt by a wireless device 130, such as a wireless phone, PDA, and/or the like. As another example, if the user device is a telephone (wireless, traditional, etc.), the computer system 105 may be configured to communicate with the consumer by transmitting a voice message (which may be received directly by the consumer via a telephone and/or may be saved on a voicemail system accessible to the user). Similarly, if the user device is a facsimile machine, the computer system 105 may be configured communicate with the consumer by transmitting a facsimile message.

In yet other cases, the computer system 105 may be configured to communicate with a user via relatively short-range wireless communication techniques, such as WiFi, WiMAX, radio frequency identification (“RFID”), near field communications (“NFC”) and/or the like. Merely by way of example, the consumer might carry a token (which can be a wireless device or any other type of device capable of such communication), and the computer system 105 (and/or another device in communication with the computer system 105) may be configured to communicate with the token to identify the consumer, as described below for example. Additionally, however, the computer system 105 can use these wireless communication techniques for other purposes, such as those described above (e.g., providing notification to users, receiving data from users about preferences, etc.).

It should be appreciated that, while in many cases the computer system 105 may itself be configured with the appropriate hardware and/or software to communicate with a consumer, merchant, and/or the like, in other cases, such communication may be handled on behalf of the computer system 105 by an intermediary device. Two examples of this concept are described above (a web server and an SMTP server), but other possibilities exist as well. Merely by way of example, a facsimile server and/or gateway may be employed to transmit facsimile communications, while a voice response unit (“VRU”) may be employed to transmit voice communications. Similarly, a wireless gateway (and/or other components of a wireless telephone network) may be used to provide communications between computer system 105 and a user device. Based on the disclosure herein, one skilled in the art will appreciate that a variety of intermediary devices may be used, depending on the communication techniques and/or the user devices with which the computer system 105 communicates.

In a set of embodiments, the computer system 105 is in also in communication with one or more point of sale devices 135. Any of a number of different types of point of sale devices 135 can be supported by various embodiments. Merely by way of example, in some cases, a point of sale device 135 might be a point of sale terminal (which might be configured to obtain data from MICR-encoded documents, such as paper checks, magnetic strips, such as those found on credit cards, and/or the like) of which several varieties are commercially available from vendors such as Verifone, Inc., First Data Corp. and the like. In other cases, a point of sale device 135 might comprise (and/or be incorporated within) a cash register, a merchant computer terminal, and/or the like. Hence, the term “point of sale device” is used broadly herein to refer to any type of device that can be employed by a merchant to collect payment and/or information at the point of sale of goods or services, and/or to provide communication between the point of sale and the computer system 105.

As described in further detail below, the point of sale device(s) 135 can be used to transmit (and the computer system 105 can be configured to receive) transaction data about a transaction involving a consumer. In particular embodiments, this transaction data might include, for example, data about a transaction for a product about which the customer has received promotional information (and/or a promotional discount). The computer system 105, in such embodiments, may be configured to process that transaction (e.g., using an automated clearinghouse (“ACH”) network, a credit card network, and/or the like, depending on the consumer's chosen form of payment), to apply any applicable discounts to the transaction (e.g., to the price of the product), to generate an electronic receipt, to instruct the point of sale device 135 not to print a paper receipt, etc., in accordance with various embodiments.

In a set of embodiments, a point of sale device 135 is associated with a merchant (which may be a different entity than a promotional provider that operates the computer system 105). In some such embodiments, the computer system 105 may be configured to communicate with the point of sale device 135 through an intermediary computer 140, which might be a host computer operated by the merchant, a transaction provider (e.g., financial institution, payment processor, etc.) for the merchant, and/or the like. In other embodiments, as illustrated by the broken lines on FIG. 1, the computer system 105 might be configured to communicate directly with one or more point of sale devices 135.

In a novel aspect, certain embodiments can be provide promotional programs through a plurality of different merchants, while still maintaining each merchant's information security. Merely by way of example, the computer system 105 can maintain a consumer profile that allows the consumer to receive promotional information from a variety of promoters (which, as noted above, might be manufacturers, distributors, retailers, etc.) and purchase a product covered by that information from a merchant of the consumers choosing (assuming, of course, that the promotion as available through that merchant).

To illustrate this concept, consider a case in which a consumer has indicated that he is interested in receiving promotional information about digital cameras. Based on this indication, the computer system 105 might make available to that consumer a first promotional discount on a first camera from a first camera manufacturer and a second promotional discount on a second camera from a second camera manufacturer. If the user chooses to purchase the first camera, he could do so at either a first retailer or a second retailer. In either case, when the consumer purchases the camera, the computer system 105 will apply the appropriate discount to the purchase price of the camera.

As another variation on this concept, the retailers themselves (rather than the manufacturers) might offer promotional discounts on various products. If the consumer is notified of a discount on a camera from a first retailer, the consumer, upon purchasing the camera from the first retailer, will automatically have the discount applied by the computer system 105. If the consumer, however, elects to purchase the camera from a second retailer, which has not offered any promotional discounts through the computer system 105, no discounts will be applied in this scenario.

Accordingly, to support such embodiments, the computer system 105 might be in communication with a plurality of point of sale devices 135, each associated with a different merchant (e.g., retailer), including a first point of sale device 135a associated with a first merchant and a second point of sale device 135b associated with a second merchant. As appropriate, the communication between the computer system 105 and the first point of sale device 135a might be provided by a first merchant computer 140a operated by the first merchant (or an agent thereof), while the communication between the computer system 105 and the second point of sale device 135b might be provided by a second merchant computer 140b operated by the second merchant (or an agent thereof). (It should be recognized, of course, that the system 100 is scalable; while, for ease of illustration, FIG. 1 depicts only two point of sale devices 135 and merchant computers 140, any number of point of sale devices 135 may be supported, among any number of merchants.)

The computer system 105 might also be in communication with one or more other computer systems 145 for various purposes. Merely by way of example, a computer system 145 might be used by a promoter to communicate promotional information from that promoter to the computer system 105 (at which point the promotional information is added to the promotions database 115).

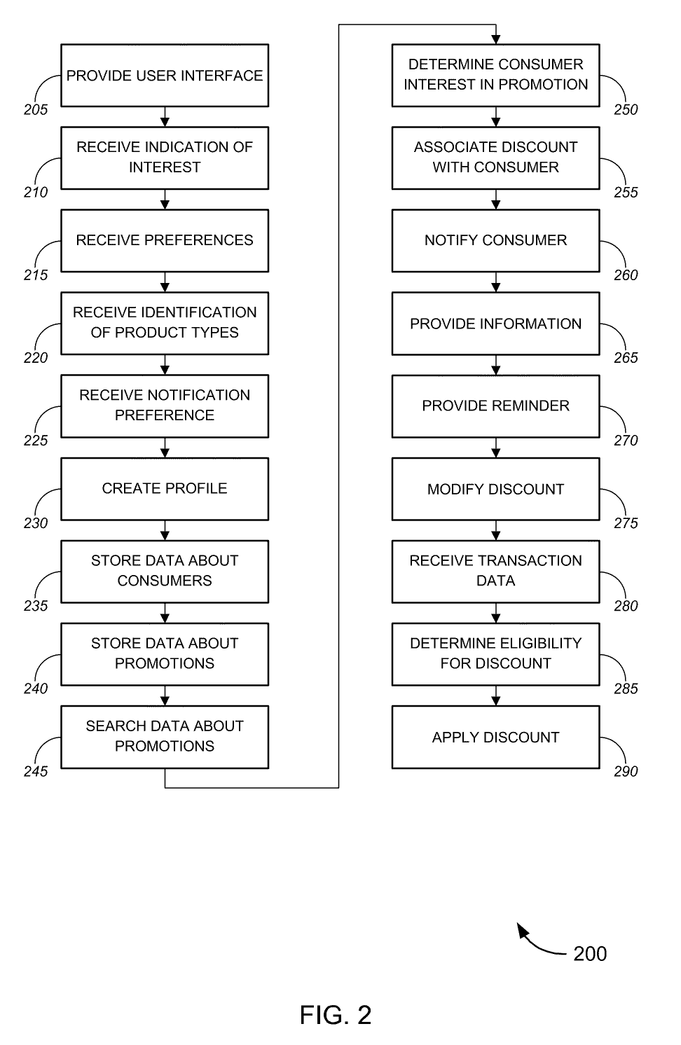

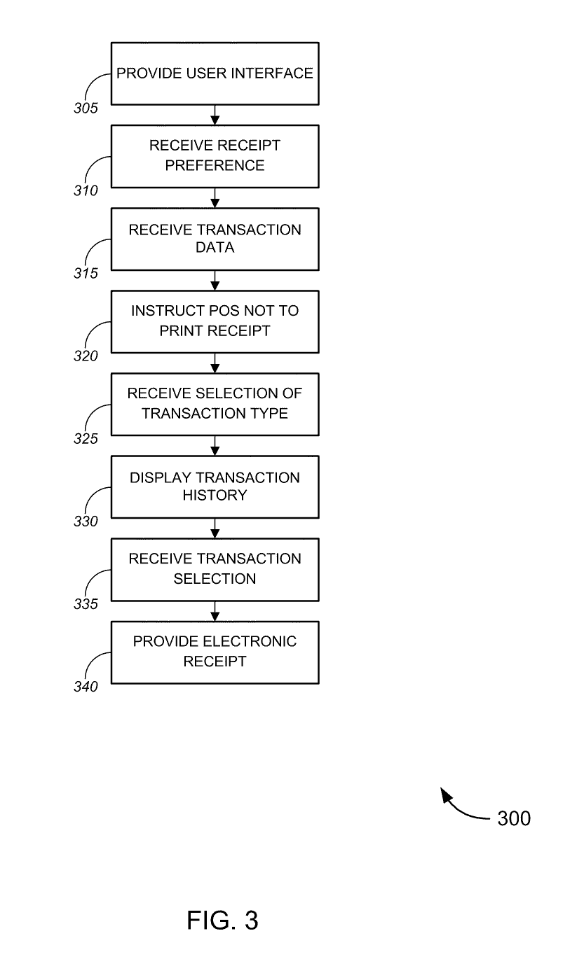

FIGS. 2 and 3 illustrate various methods that can be used to provide promotional programs and/or to enhance consumer satisfaction with, and/or participation in, promotional programs. While the various methods described herein are illustrated, for ease of description, as different methods, it should be appreciated that the various techniques and procedures of these methods can be combined in any suitable fashion, and that, in some embodiments, the methods depicted by FIGS. 2 and 3 (and any of the other methods described herein) can be considered interoperable and/or as portions of a single method. Moreover, while the methods described herein can be implemented by (and, in some cases, are described below with respect to) the system 100 of FIG. 1 (or components thereof), these methods can be implemented using any suitable hardware implementation. Similarly, while the system 100 of FIG. 1 can operate according to the methods described herein (e.g., by executing instructions embodied on a computer readable medium), the system 100 can also operate according to other modes of operation and/or perform other suitable procedures.

Turning to FIG. 2, a method 200 can be used to provide promotional information and/or for enhancing consumer satisfaction (e.g., by allowing consumers to participate selectively in promotional programs). The method 200 comprises providing a user interface (block 200). In an aspect, the user interface provides a means for a consumer (or another user) to interact with a computer system (such as the computer system 100 of FIG. 1) that manages a promotional program. Hence, for example, the user interface can be used to output information for a consumer (or another user), e.g., by displaying the information on a display device, printing information with a printer, playing audio through a speaker, etc.; the user interface can also function to receive input from a consumer (or other user), e.g., using standard input devices such as mice and other pointing devices, keyboards (both numeric and alphanumeric), microphones, etc. The procedures undertaken to provide a user interface, therefore, can vary depending on the nature of the implementation; in some cases, providing a user interface can comprise displaying the user interface on a display device; in other cases, however, where the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device (e.g., generating a web page, transmitting the web page to the consumer device, receiving a web-based form from the consumer device, etc.).

As noted herein, various embodiments can support communication with consumers (and other users) using many different techniques. It should be appreciated, therefore, that a user interface may be provided via a variety of techniques as well. Merely by way of example, if the computer system is configured to communicate with a user via a client computer, the user interface might be displayed on that client computer, through a dedicated application (such as a client-server application, in which a client component on the client computer displays the user interface and also communicates with the server application on the server computer). Alternatively, the user interface on a client computer (or any other appropriate consumer device) might be a Web interface, in which the user interface is provided through one or more web pages that are served from the computer system (or a Web server in communication with the computer system) and are received and displayed by a Web browser on the client computer (or other capable consumer device). The web pages can display output from the computer system and receive input from the user (e.g., by using Web-based forms, etc.). A variety of techniques can be used to create these Web pages and/or display/receive information, such as JavaScript, Java applications or applets, dynamic HTML and/or AJAX technologies.

In other cases, the user interface can be provided, e.g., through a facsimile machine (for example, for transmitting facsimile messages that can be printed and/or viewed by a consumer), though a voice interface such as a VRU (for example, by providing audio output through a telephone and/or by receiving and interpreting spoken and/or touch-tone input from a user though the telephone). In further cases, the user interface might be provided via a wireless device (such as a phone or PDA), either through appropriate Web pages (such as WAP pages), though a Java application or applet installed on the wireless device, and/or the like.

The method 200 further comprises receiving, from a consumer, an indication that the consumer is interested in participating in a promotional program, which might be a promotional discount program, an advertising program and/or the like (block 210). Typically, this information is received via the user interface. In some cases, this indication will take the form of an enrollment transaction, in which the consumer enrolls in a promotional program. As part of the enrollment transaction, the consumer might be prompted to provide various biographical information, such as name, address, telephone number, etc.

At block 215, the method comprises receiving—typically at the computer system and via the user interface—preference data from the consumer. The computer system may prompt the consumer for some or all of this preference data during the enrollment transaction. In other cases, the consumer may provide preference data after the enrollment process (either in the first instance or to update/modify preference data previously provided) via the user interface.

This preference information can include a variety of information. For example, as described in more detail below, the preference information can include an indication of a preference for receiving electronic receipts instead of (or additional to) paper receipts. Another type of preference information that the consumer may be prompted to provide (and that the computer system may receive from the consumer) is an identification of products (or types of products) about which the consumer would like to receive promotional information. For instance, if the consumer is in the market for a new DVD player, the consumer can specify, via the user interface, that the consumer would like to receive promotional information (which can include any of a variety of types of information, such as advertising materials, promotional discounts, reviews and other third-party information, and/or the like) about DVD players.

In accordance with a set of embodiments, this identification of products can be performed at varying levels of granularity (perhaps as specified by the consumer). Merely by way of example, the consumer might specify merely that he is interested in receiving promotional information about DVD players. Alternatively, the user might specify a particular brand of DVD player, a particular model of DVD player, a particular feature set, a particular price range, and/or the like, to further refine the identification of the type of product that the user would like to receive promotional information about.

Similarly, the consumer may be given the option to select the types of promotional information that the consumer would like to receive. For instance, the consumer might elect to receive promotional discounts about the identified product/product type, but not to receive other promotional information, such as advertisements not associated with discounts.

In an embodiment, the user interface provides a variety of flexible options to allow the user to identify products and other preferences. In particular, the user interface may allow the user to specify one or more criteria for selecting the types of products about which the consumer is interested in receiving promotional information (including without limitation promotional discounts.) Such criteria can include, without limitation, products offered by certain manufacturers and/or retailers, products within a category of interest, products within a certain price range, products of a certain age (i.e., products that have come on the market within a specified amount of time), products of a certain rating (e.g., products rated at or above a particular level, based on third party rating agencies, ratings from other users, etc.), and/or the like.

Merely by way of example, in some cases, the user interface might display a list of product types and allow the user to select one or more product types about which the user would like to receive promotional information. In some instances, this process can be performed interactively at increasing levels of granularity; merely by way of example, the consumer may be presented with a relatively general list of product categories, including categories such as “vehicles,” “home and garden,” “electronics,” “sporting goods,” “books and media,” and the like. Upon selecting one of these categories (e.g., by selecting a hyperlink associated with the category name), the consumer might be presented with another list of categories at a more granular level. Hence if the consumer selects “electronics,” the user interface might then present the user with a list of subcategories within the “electronics” category, such as “computers and office equipment,” “cameras,” “audio,” “video,” and the like. In such embodiments, the consumer can “drill down” through a hierarchy of categories to reach a particular product and/or category of products about which the consumer would like to receive information. In an aspect, the consumer may be given the opportunity to select a category at any level of the hierarchy, depending on how specifically the consumer would like to identify the product in which is interested.

The consumer may also be given other options for identifying products in which the consumer is interested. Merely by way of example, the user interface might provide a text field to allow the consumer to enter a search query (using natural language, Boolean terms, and/or any other search techniques known in the art); this search query than can be used to identify products in which the consumer may be interested. A list of search results may be displayed via the user interface to allow the consumer to identify products by selecting them; alternatively and/or additionally, the search query may be maintained in the consumer's profile and/or may be used dynamically by the computer to identify products at a later time without further user interaction.

Additionally, the system might provide, in the user interface, a facility to allow the consumer to select from pre-determined search modifiers either when performing a search for products or when browsing categories. Examples include price ranges, product features that are specific to particular products (so, for example, if a user is browsing a “cameras” category, the user interface might provide preconfigured options (in the form of checkboxes, etc.) to allow the consumer to specify an image resolution, a brand, and/or other features common to cameras.

These selection tools can be used by the consumer to select any number of product types (which can include both specific products and categories of products, if desired) about which the consumer would like to receive discounts and/or other promotional information. Optionally, the user interface might display for the consumer a list of the identified product types, to allow the consumer to review and/or modify the list of product types the consumer has identified.

In some cases, one or more types of products (including specific products and/or categories of products) may be suggested by the computer system, via the user interface, for selection by the consumer. These suggestions may be based on a demographic profile of the consumer (e.g., types of products the consumer has previously expressed interest in and/or purchased, the geographic location of the consumer, the income level of the consumer, and/or the like). Merely by way of example, the user interface may have an option to allow the user to request that the computer system provide such suggestions; alternatively and/or additionally, the user interface might provide such suggestions without prompting (in a sidebar, etc.) based, for example, on products that the consumer is currently viewing in the user interface.

Another type of preference that the consumer might specify (either during enrollment or at another time) is a notification preference. In particular, the computer system might receive, form the user, input about one or more desired notification techniques (block 225). In some embodiments, the consumer might identify multiple notification techniques, possibly with a prioritization among the identified techniques. Notifications provided to the consumer (as described below for example) then may be provided via the identified notification techniques. As noted above, many notification techniques (including without limitation notifications sent to a variety of consumer devices) can be supported by various embodiments. In some cases, the user interface will display for the consumer a list of all techniques supported by a computer system, and the consumer can select one or more desired notification techniques from this list (e.g., by selecting a checkbox associated with each of the desired notification techniques). If necessary, the consumer may be prompted for additional information associated with a desired notification technique. For example, if the user desires to be notified by e-mail, the user interface might prompt the user for an e-mail address, while if the user desires to be notified by SMS message, user interface might prompt the user for a wireless phone number. (Of course, this information may be collected earlier in the enrollment process as part of the consumer's biographical information, in which case the user interface might either forgo the prompting or simply ask the consumer to confirm information provided earlier.)

Upon completion of the enrollment transaction (e.g., entry of the necessary information by the consumer into the user interface and/or submittal of the information, as in the case of a Web interface), the computer system creates a consumer profile for the consumer (block 230). As noted above, a consumer profile may comprise a record in a consumer profile database. In an embodiment, the consumer profile includes an identifier for the consumer—this identifier might be a data element that is provided by the consumer (such as a telephone number, credit card number, etc), or it might be a data element that is assigned (perhaps randomly or quasi-randomly) by the computer system, or it might be a combination thereof. In another embodiment, the consumer profile also stores the preference information provided by the user at enrollment and/or at another time, including in particular preference information about products that interest the consumer (i.e., products about which the consumer would like to receive at least some type of promotional information). In some cases, a single consumer might have multiple consumer identifiers (e.g., a telephone number and two credit card numbers), to make it easier to identify the consumer in the manner described below.

Hence, in a set of embodiments, the method 200 comprises storing, in a data store (such as a consumer profile database to name an example), data about a plurality of consumers (block 235). Typically, this data will take the form of a consumer profile for each of the plurality of consumers. The method 200 may also comprise storing, in another data store (e.g., a promotions database), which might be, but need not be, the same data store in which the consumer profiles are stored, data about a plurality of sets of promotional information (block 240). In an embodiment, a set of promotional information comprises data about a promotional discount on a particular product (or group of products). This data might comprise an identification of the product(s), data specifying an amount of the discount (which can be a specified value or can be a value calculated based on other data, such as the identity of the consumer to whom the discount is offered, the length of time elapsed before the product is purchased, the quantity purchased, etc.), data specifying a term and/or expiration date of the discount offer, and/or the like.

At block 245, the computer system searches the promotions database (or other appropriate data store) to identify a promotional discount (or other set of promotional information) to be offered and/or provided to a particular consumer. In an aspect, this search may based on the types of products that the consumer has identified as being those that the consumer is interested in receiving promotional information about (as described above, for example). For example, if a consumer indicates that he is interested in receiving discounts and/or information on cameras, and the metadata about a particular discount offer indicates that the offer pertains to cameras, that discount offer will be returned as part of the search results. In another aspect, the search might be based on offers or information that the consumer is eligible to receive (based, for example, on information in the consumer's profile, such as demographic information, past purchasing habits, etc.).

At block 250, the system identifies a promotional discount (and/or any other promotional information) that pertains to a particular product and/or determines that the product is the type of product about which the consumer would like to receive promotional information. This identification and/or determination may be based on the search for promotional information to be offered to that consumer—e.g., the computer will identify a promotional discount (or other promotional information) by performing the search described above and/or will determine, based on the fact that the identified set of promotional information meets the search criteria for that consumer, that the identified set of promotional information pertains to a product for which the customer is interested in receiving promotional information.

In other embodiments, different techniques may be used to identify promotional information and/or determine if that information pertains to product that the consumer is interested in. For example, in some cases, the user interface may display for user a list of promotional offers (e.g. discount offers) and allow the consumer to choose the offers that interest the consumer. This technique may be used both identify promotional information and to determine that the customer is interested in the product to which information pertains. Additional promotional information that might interest the consumer may also be identified based on the consumer's identification of offers in which he is interested. For example, the computer system might identify additional promotional offers with similar characteristics (e.g., relationship a similar products, similar magnitude of discount, similar retailers, enter the like.)

In a set of embodiments, the procedures for searching data about the promotions, identifying promotions, and/or determining that the promotions pertained to products that interest the consumer may be repeated periodically (e.g., on a scheduled basis) and/or on-demand by the consumer.

After a promotion (which can include a promotional discount and/or any other type of promotional information) has been identified as being appropriate for a particular consumer (e.g., using the techniques described above), a promotion can be associated with the consumer's profile. In an aspect, this association is based on the determination that the promotion is appropriate for the consumer (i.e., that the product to which the promotion pertains is of the type for which the consumer would like to receive promotional information and/or, in some cases, that the promotion is one for which the customers eligible). Many different techniques can be used to associate a promotional offer, such as a discount, with a consumer profile. Merely by way of example, if one or more relational databases are used to store consumer profiles and/or promotional information, a relational link may be established between the consumer's profile and the discount or other promotional information. In other cases, an identifier of the consumer may be stored in a database record for the promotional information and/or an identifier of the promotional information may be stored in the consumer profile. In yet other embodiments, a separate table may be used to correlate consumer identifiers with particular discount or other promotional information. Other techniques may be used as well.

If the promotion includes a discount, the consumer may be notified about the availability to that consumer of the discount (block 260). If the promotion includes additional promotional information (such as advertisements) and/or the promotion does not include a discount, the promotional information may be provided to the consumer (block 265). In either case, the user interface may be used to notify the consumer and/or provide the information. (As noted above, many different techniques may be used to notify the consumer and/or provide the information, including without limitation transmitting an e-mail message, providing a web page that displays the information, transmitting a message for reception by a wireless device, and/or the like.) In some cases, a notification and/or promotional information may comprise rich media, such as one or more images, video clips, audio clips, and/or the like. In an aspect, this rich media may describe and/or demonstrate the product which the promotion pertains. (Of course, the use of rich media may be conditioned on the ability of the receiving device to play the rich media.)

As noted above, in some cases the consumer may specify a notification preference that identifies a desired notification technique; in such cases, the notification may be provided to the consumer using the desired notification technique. Merely by way of example, if the consumer identifies a desired notification technique, and identification may restore the consumer profile, and when the computer system notifies the consumer, the computer system might first check the consumer profile to determine how to provide the notification.

As described elsewhere herein, in accordance with some embodiments, the computer system participates in purchase transactions for products that are subject to promotions (and perhaps other products as well). In such cases, the computer system may maintain a record of each such transaction. Accordingly, the computer system may be configured to determine, after a specified period of time, whether the consumer has responded to promotion (e.g., by purchasing the promoted product). If the computer system determines that the consumer has not yet responded to the promotion, the computer system may be configured to provide a reminder to the consumer of the promotion (e.g., a reminder of the availability of a promotional discount associate with the promotion) (block 270). This reminder may be provided in the same fashion as the notification described above.

In some cases, the computer system may be configured to modify a discount offered to a particular consumer (block 275). Discounts may be modified for a variety of reasons. Merely by way of example, a discount offered to a particular consumer may be modified based on information in a consumer's profile; for instance, if a particular promotion features a 20% discount on a product, but historical purchase data about the consumer (which might be stored in a consumer's profile) indicates that the consumer is more likely to respond to a 25% discount than a 20% discount, the discount offer to that consumer might be modified to 25%. Similarly, if the consumer's profile indicates that consumer prefers a particular brand of product but a promotion pertains to similar product of a different brand, that promotion's discount may be increased to incentive the customer to purchase the promoted product.

In other cases, a promotional discount may be modified (e.g., an amount of the discount may be increased or decreased) over time. Merely by way of example, the amount of the discount may decrease over time. For instance, if the consumer is notified at a particular time of the availability of a promotional discount, and the consumer purchases the promoted product at a later time (as evidenced, for example, by the receipt by the computer system of transaction data related to the purchase, as described in further detail below), the amount of the promotional discount may be based on an elapsed time between when the consumer is notified of the discount and when the consumer purchases the product.

In a novel aspect of some embodiments, a promotional discount offered to a consumer can be applied to that consumer's purchase of the promoted product without forcing the consumer to present a coupon, identify an offer number, or take any other steps beyond simply purchasing the promoted item (and, optionally, providing an easy to remember consumer identifier at the time of purchase). As noted above, a single promotional program can be implemented with a plurality of retailers (although this is not required). Hence, when a consumer visits a retailer that is participating in the promotional program (either in person, online etc.) the consumer identifies himself as a participant in the promotional program, either explicitly (e.g. by providing the retailer a consumer identifier, which allows identification of the consumer's profile) or implicitly (e.g., by using a credit card, bank account, etc. that is associated with a consumer profile). Once the consumer has been identified, any pertinent discounts for which the consumer is eligible may automatically be applied to the consumer's purchase.

As noted above, in many embodiments the computer system that manages the promotional program is communication with the point of sale for the promoted products; this can allow the managing computer system to participate in the purchase transaction, so as to apply any promotional discount the pertains to purchase product. For example, when the consumer visits a retailer to purchase a promoted product, the retailer creates a purchase transaction for the product and transmits transaction data about the transaction to the computer system (typically, these steps can be performed automatically by point of sale device when the consumer “checks out” at the point of sale)—it should be noted that the transaction need not be completed before the transaction data is sent to the computer system; in fact, in many cases, the transaction data is transmitted to the computer system before the transaction has been completed, in order that the computer system can apply appropriate discounts to the transaction as noted below, although this is not required. This transaction data includes a consumer identifier (which, as noted above, can be provided explicitly or implicitly by the consumer) and one or more product identifiers (which might be stock keeping unit (“SKU”) values, product model and/or serial numbers, or any other values that can identify a product) for the product(s) being purchased by the consumer.

Upon receiving this transaction data (block 280), e.g., from a point of sale device at a retailer, the computer system determines (based on the consumer identifier and the product identifier(s) whether the consumer is eligible for any promotional discounts on any of the identified products being purchased (block 285). Merely by way of example, the computer system might determine whether the consumer's profile has associated therewith any promotional discounts that pertain to the products being purchased.

If the computer system determines that the consumer is eligible for a discount, the computer system applies that discount to the purchase price of the product (block 290). The application of the discount can be performed in a variety of ways, depending on the configuration of the computer system and its relationship with the point of sale device. Merely by way of example, in some embodiments, the computer system might transmit an instruction to the point of sale device to apply the discount (e.g., an instruction to reduce the purchase price of the product by the amount of the discount). In other cases, the computer system managing the promotional program might interface with a host computer operated by the retailer, and the computer system might inform the retailer's host computer that a discount should be applied. In other embodiments, the discount might be applied in the form of an automatic rebate that is awarded by the computer system after purchase. Other possibilities exist as well.

FIG. 3 illustrates a method 300 of providing electronic receipts to a consumer. The method 300 can be used to encourage consumers to participate in a promotional program and/or can be used in conjunction with the method 200 described above. The method 300 comprises providing a user interface (block 305). Techniques similar to those described above can be used provide the user interface; in fact, in some cases the same user interface is used by consumers for both registering for promotions and registering for electronic receipts, and the registrations can be done simultaneously if desired.

At block 310, the computer system receives a notification from the consumer, e.g., via the user interface, that the consumer would prefer not to receive paper receipts and/or that the consumer has a preference for receiving electronic receipts. (If desired, the consumer can provide this information when enrolling in a promotional program, as described above.) This preference can be stored in the consumer's profile, similar to other preference data described above. In an aspect, this preference information is received at the computer system prior to the consumer's purchase of a particular product and is stored in the consumer's profile until the consumer purchases the product. In another aspect, however, as noted below, a consumer instead may provide this preference at the time of purchase.

When that consumer visits a retailer to purchase the product, transaction data from a purchase transaction for the product is transmitted from a point of sale device at the retailer to the computer system managing the promotional program, as described above. (In an alternative embodiment, as noted above, the consumer may indicate to the retailer, and or the point of sale device may communicate to the computer system, the consumer's desire not to receive electronic receipts. The computer system may add this preference to the user's profile at this time.) Upon receiving the set of transaction data (e.g., from a point of sale device) (block 315), the computer system identifies the consumer, determines based on the consumer's profile at the consumer prefers not to receive paper receipts, and transmits an instruction to the point of sale device not to print a receipt for the transaction (block 320). A receiving less instruction, the point of sale device (and/or an associated cash register) does not print any receipt for the transaction, but instead might display message (e.g. on a display screen, etc.) indicating that no receipt will be printed.

Thereafter, if the consumer desires a record of the transaction, the computer system can provide an electronic receipt, which the consumer can download, save, print, etc. as desired. Merely by way of example, the computer system may be configured to store a record of each transaction for each consumer participating in the promotional program (based on received transaction data)—this can include transactions between a consumer and a variety of retailers, so long as the retailers participate in the promotional program. This record of each transaction can include an electronic receipt (or sufficient information to compose an electronic receipt at a later time, such as the date of the transaction, the item(s) purchased, the price of each item, and any other data typically included on a retail receipt).

When the consumer would like to view his past transactions, he can access the computer system via the user interface (which, as noted above, can be provided via any appropriate consumer device using a number of techniques) and request a transaction history. At this point, the computer system provides, via the user interface, a display of a transaction history for that consumer, which can allow the consumer to view the transaction history. In an aspect, the transaction history provides information about some or all transactions associated with that consumer's profile; for example, the transaction history may comprise a list of transactions (e.g., with every entry on the list comprising a date, retailer and/or amount of the transaction). In an embodiment, if the transaction history is provided as a web page, each entry on the list of transactions might be formatted as a hyperlink, to allow the consumer to select a hyperlink to see an electronic receipt for the selected transaction. Optionally, the consumer may be given the option to select a type of transaction for which the consumer would like to see a transaction history (e.g., transactions between certain dates, transactions with a certain retailer, etc.), and the displayed transaction history therefore can be limited to transactions of the selected type.

Hence, the method 300 may comprise receiving, via the user interface, a selection of a transaction (block 335), and/or providing an electronic transaction receipt for the transaction (block 340). In some cases, the electronic transaction receipt may be generated at or around the time of the transaction and stored by the computer system for later access by the consumer; in other embodiments, the computer system may generate the electronic receipt upon demand by the user. Providing an electronic transaction receipt can comprise any of a variety of operations, including without limitation displaying the electronic receipt for the consumer, via the user interface; providing one or more electronic receipts in a format suitable for downloading and/or import into a financial software application, such as Quicken™; providing electronic receipt for download in an archival format (such as portable document format (“PDF”); and/or the like. In some cases, the electronic receipt may be digitally signed, to prevent fraudulent use of the electronic receipt.

Advantageously, because the computer system can track both the promotional offers provided to consumer and the consumer's response to those promotional offers (e.g., by receiving transaction data from transactions involving the consumer), certain embodiments provide the ability to gather metrics on the effectiveness of different promotional campaigns. Merely by way of example, a promoter might choose to offer a particular discount to some consumers and offer another discount to other consumers (these discounts can vary in different ways, such as in the amount of the discount, in the conditions for receiving discount, in the timing of the discount, and/or the like), and embodiments can be configured to consolidate data about the consumers' purchase of the promoted product. In this way, the computer system can present data to a promoter to allow the promoter to see, in the aggregate, which of the two promotional campaigns is more effective. Similarly, a promoter might choose to provide two different sets of advertising materials to two sets of consumers, and the computer system can determine, based on consumer response, which of the two sets of advertising materials is more effective.

Thus, in a situation in which a particular promotion is offered to a plurality of consumers, the computer system can store a record of which consumers received the promotion and can also store a record of which of those consumers responded to the promotion. Similarly if a second promotion is offered to a second plurality of consumers, the computer system can store a record of which consumers received the second promotion and can also store record of which of those consumers responded to the second promotion. The computer system can also compare the response rates to the first and second promotions to determine which promotion is more effective. Various techniques for gathering and employing such consumer intelligence are described in further detail below.

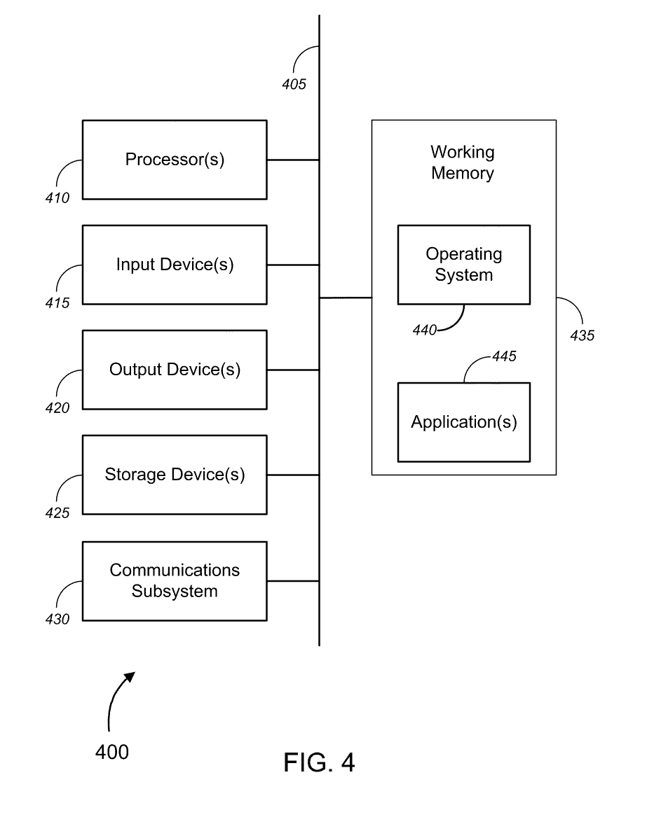

FIG. 4 provides a schematic illustration of one embodiment of a computer system 400 that can perform the methods provided by various other embodiments, as described herein, and/or can function as a computer system, a host computer, and/or any of the user devices described herein (including without limitation a client computer, wireless device, and/or the like. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 425. Volatile media includes, without limitation, dynamic memory, such as the working memory 435. Transmission media includes, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

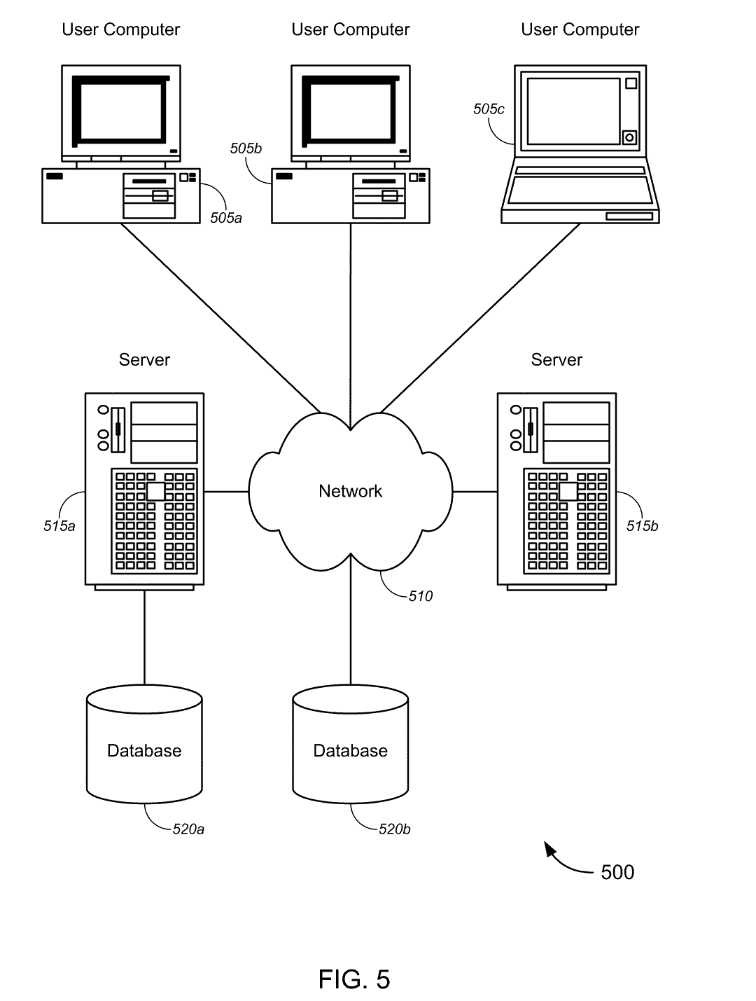

As described above, a set of embodiments provides computer systems. FIG. 5 illustrates a schematic diagram of a system 500 that can be used in accordance with one set of embodiments, such as the system 100 described with respect to FIG. 1. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods provided by various embodiments (as described above, for example), as well as one or more office applications, database client and/or server applications, and/or web browser applications. Alternatively, the user computers 505 can be any other electronic device, such as a gaming or entertainment console, set-top box, networked television, thin-client computer, electronic book, automotive computer, Internet-enabled mobile telephone, and/or personal digital assistant, capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 505 and/or another server 515. In some embodiments, an application server can create web pages dynamically for displaying the information in accordance with various embodiments, such as for providing a user interface for consumers. Data provided by an application server may be formatted as one or more web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 535 can be a relational database, such as an Oracle database, that is adapted to store, update, and retrieve data in response to SQL-formatted commands. The database might be controlled and/or maintained by a database server, as described above, for example.

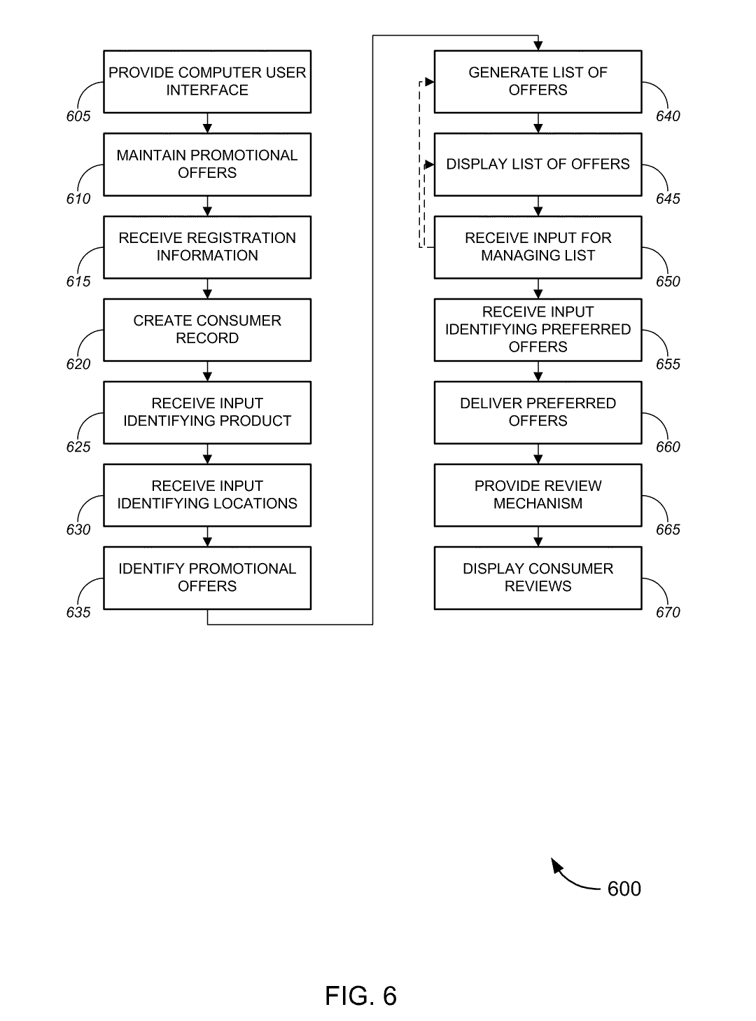

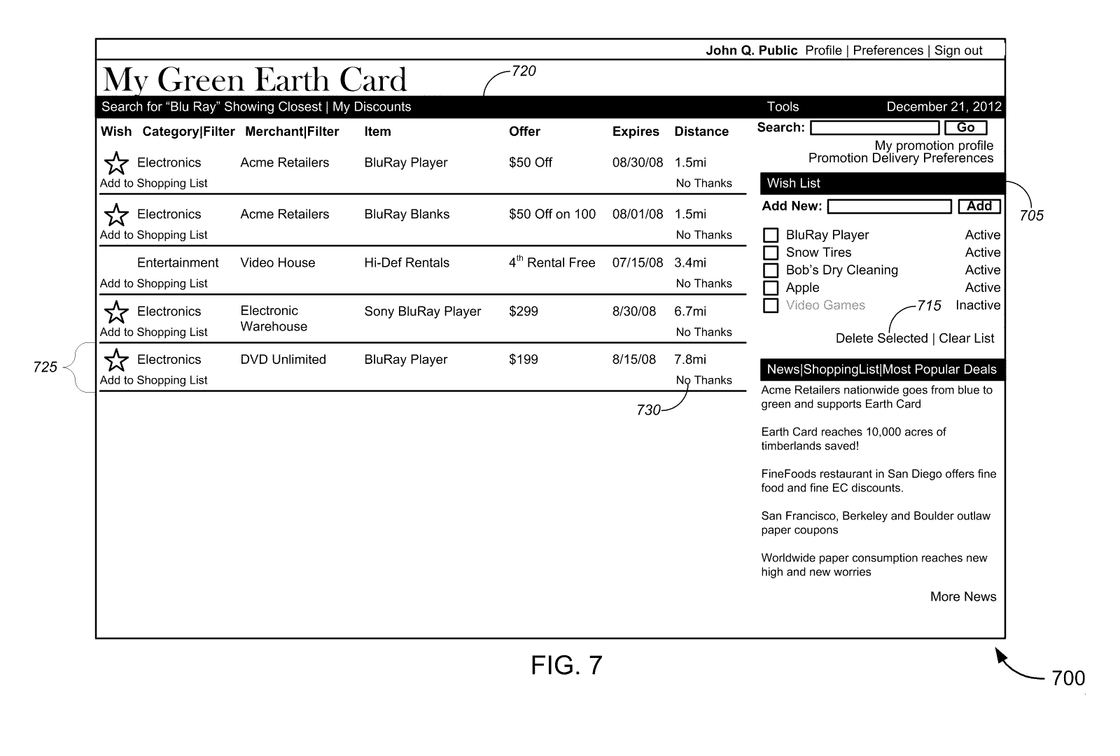

Certain embodiments may implement a variety of different features. Merely by way of example, a set of embodiments can provide a consumer with an interface for selecting and/or managing promotional offers (and/or other promotional information) that is of interest to the consumer. To illustrate an example of such functionality, FIG. 6 depicts a method 600 of providing promotional information to a consumer according to one set of embodiments, and FIGS. 7-17 provide exemplary screen displays from a consumer user interface in accordance with the method 600.

The method 600 comprises providing a computer user interface for interacting with a consumer (block 605). A computer user interface may comprise any technology that provides for interaction between a computer and the user, including a particular graphical user interfaces. Merely by way of example, one such computer user interface may be implemented as a Web interface, as described above. Indeed, any of the user interfaces described above may be provided as a computer user interface for interacting with a consumer.

The method 600 further comprises maintaining a plurality of promotional offers (block 610). In an aspect of certain embodiments, the plurality of promotional offers may be maintained in a database, for example by storing, updating, and are like records of such promotional offers in the database. As noted above, each promotional offer generally will pertain to a particular product (e.g., item of goods or services) offered for sale by particular merchant (which might be a retailer, distributor, and/or other promoter). In some cases, the physical location of the merchant may not be relevant to the consumer (such as in cases where the consumer plans to purchase the product online, etc.), but in other cases the physical location of merchant may be highly relevant to the consumer, for example if the consumer plans to visit the merchant location in order to purchase the product. A variety of techniques may be used to generate and/or maintain promotional offers. Merely by way of example, several merchants may participate in the promotional program facilitated by various embodiments, and each merchant may add promotional offers to a database, in the manner described below for example. In other cases, promotional offers may be added to the database in automated fashion, for example by receiving a data feed of promotional offers from merchants or others, by crawling websites that provide and/or catalog promotional offers, and/or the like.

The method 600 may further comprise receiving (e.g., via the computer user interface) a set of registration information for the consumer (block 615) and/or creating a consumer profile for the consumer (block 620). The techniques for performing these operations may be similar to the techniques described above. Merely by way of example, receiving consumer information might comprise performing an enrollment transaction, as described above. The consumer profile might be stored in a database (which could be the same database as the database in which the promotional offer records are stored, or which could be a different database), and might include a consumer identifier, as noted above, as well as some or all of the registration information provided by a consumer. In other embodiments, consumer registration information might be provided by a merchant (for example, as a data feed from a merchant's customer database, loyalty database, etc.). In such cases, the consumer may be asked (via any of the forms of communication described herein) to confirm that the consumer would like to have a consumer profile established for the promotional program managed by the systems described herein.

At block 625, the method 600 comprises receiving input identifying a type of product for which the consumer would like to receive promotional offers. This input may take one of many forms. Merely by way of example, the input might be received, similar to registration information, as a data feed from a merchant (for example, if the merchant is aware that the consumer would like to receive offers on products from that merchant). Additionally, and/or alternatively, such input might be received as user input (which typically might be provided by the consumer via the computer user interface). Merely by way of example, in some cases, the consumer might provide user input in the form of a search term, and the promotional offer database might be searched to identify promotional offer records that match the search criteria; the consumer then can be given the option to select from among the identified promotional offers.

For example, FIG. 7 illustrates a screen display 700 from a consumer user interface. In this example, the consumer has added the term “BluRay Player” to the consumer's wish list. The wish list serves as a list of search terms; the tools provided by certain embodiments use these wish list terms as search criteria (for either a one-time search or a search that may be re-executed periodically, on demand, etc.) The consumer's wish list (which may be stored in the consumer's profile) is displayed in a frame 705 on the right side of the screen) can be modified by the consumer; for example, the system might provide a mechanism (such as the field 710) for adding new wish list terms, a mechanism (such as the “delete selected” link) for deleting wish list terms, and/or a mechanism (such as the “active” links) for activating/deactivating wish list terms (an active term is used as a search criteria, while an inactive term is not used as a search criteria), and/or the like. In certain aspects, any detail about a promotional offer (product type, manufacturer, retailer, etc.) can be used as a wish list term. A frame 720 on the left side of the screen display 700 provides a list of promotional offers (embodied by promotional offer records in the database) that meet the search criteria (which, in this case, is the wish list term “BluRay Player”). (It should be noted that the computer system may incorporate stemming and synonym-analysis techniques to provide relevant search results, such that a search for “BluRay Player” would return results that include the terms “BluRay,” “Blu-Ray,” “Blu Ray,” and “Hi-Def,” to describe one example.) The user can select one or more of these promotional offers using the appropriate “Add to Shopping List” link for the selected offer.

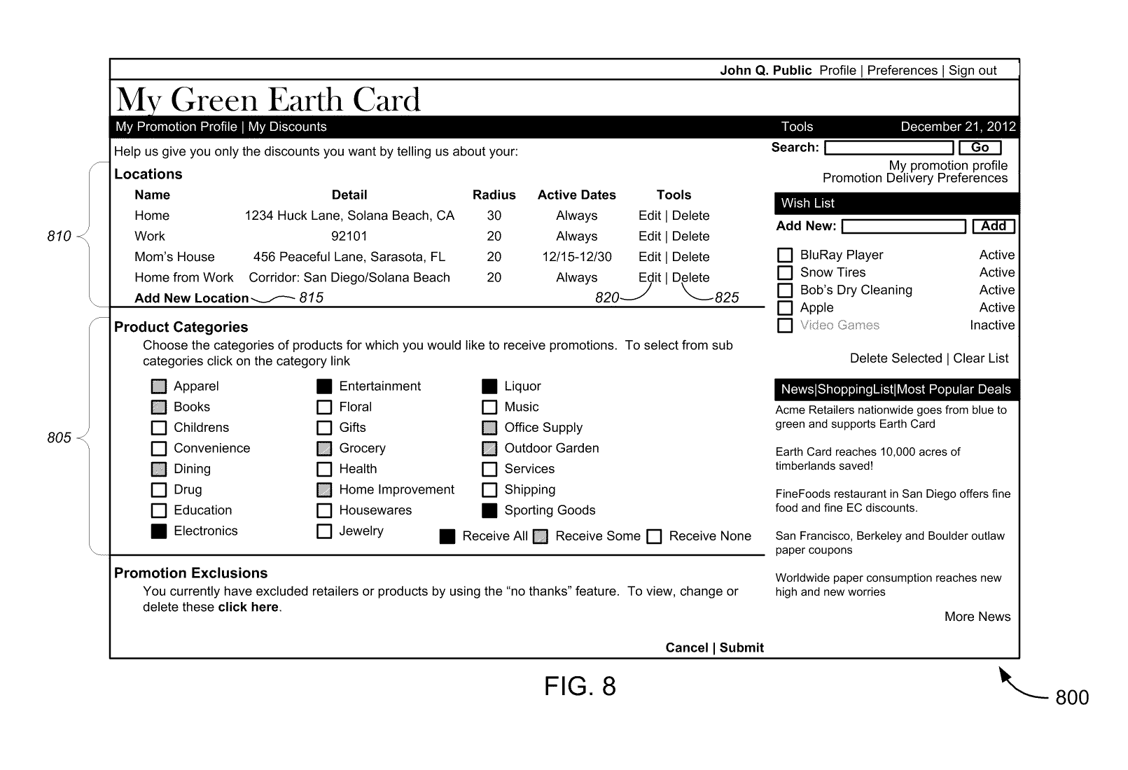

In addition (or as an alternative) to using a wish list for search terms, the consumer may select from among categories of products to identify types of products for which the consumer would like to receive promotional offers. To illustrate an example of this functionality, FIG. 8 illustrates a screen display 800 that allows the consumer to customize that consumer's profile. Of particular relevance to the particular discussion, the display screen 800 provides an input mechanism to allow the consumer to select categories of products for which the user would like to receive promotional offers. In the illustrated embodiment, the user interface screen 800 allows the consumer to select between a variety of categories (collective referred to with numeral 500), according to the consumer's preferences, for example, by clicking on an interface device (such as the checkboxes illustrated) with a mouse or other pointing device, to name one example. In an aspect of the illustrated embodiment, the checkbox associated with each category can cycle through three user-selectable modes, indicated by a black box, a white box, and a gray box, respectively. By placing a checkbox in the first mode (black), a consumer indicates that he/she would like to receive all promotional offers available (perhaps subject to other constraints, such as location, retailer exclusion etc.) on products within the selected product category. By placing the checkbox in the second mode, the consumer indicates that he/she would not like to receive any promotional offers on products in that category.

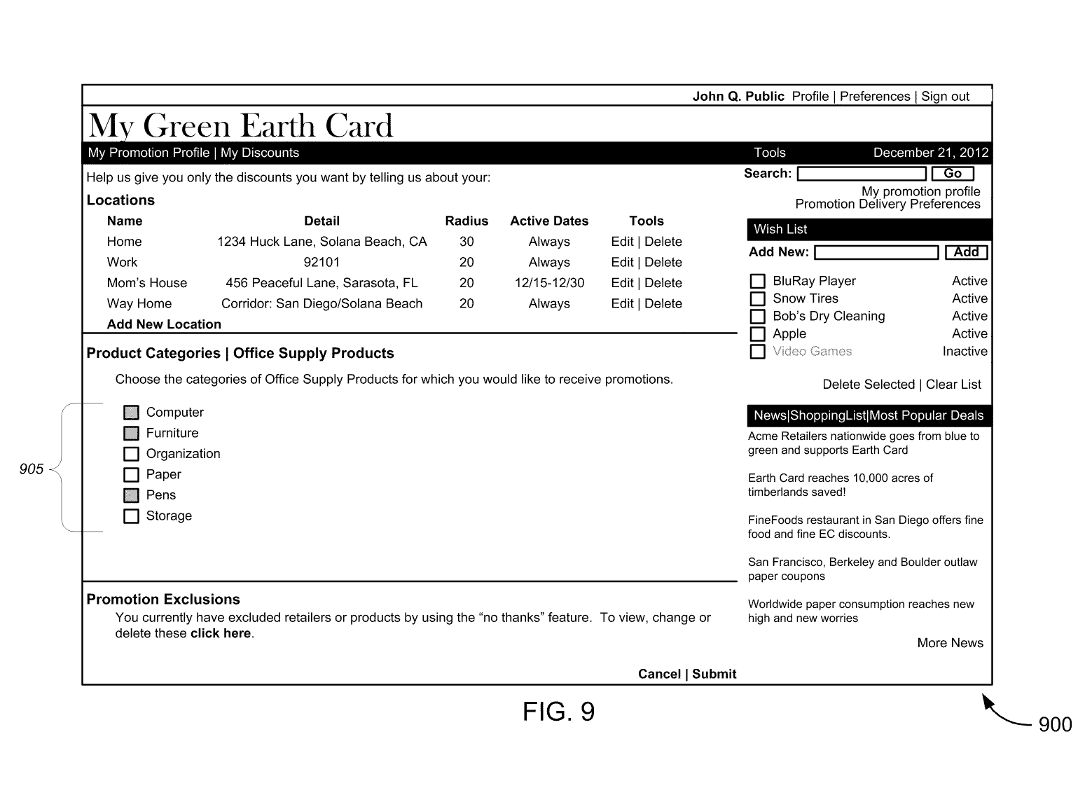

By placing the checkbox in the third mode (which is indicated by a gray box, in the illustrated embodiment), the consumer can indicate that he/she would like to receive offers on some, but not necessarily all products within the selected category. Upon receiving such a selection (e.g., upon the consumer placing the checkbox in the third mode, upon the consumer pressing a “submit” button, etc.), the computer system may display a user interface screen such as the example screen 900 depicted by FIG. 9 which. This screen provides a list of subcategories (collectively, 905), or, alternatively, products, that the consumer can select in the same fashion described above. In this way, certain embodiments provide the consumer with the ability to select, at a relatively granular level, the products and/or types of products for which the consumer would like to receive promotional offers.

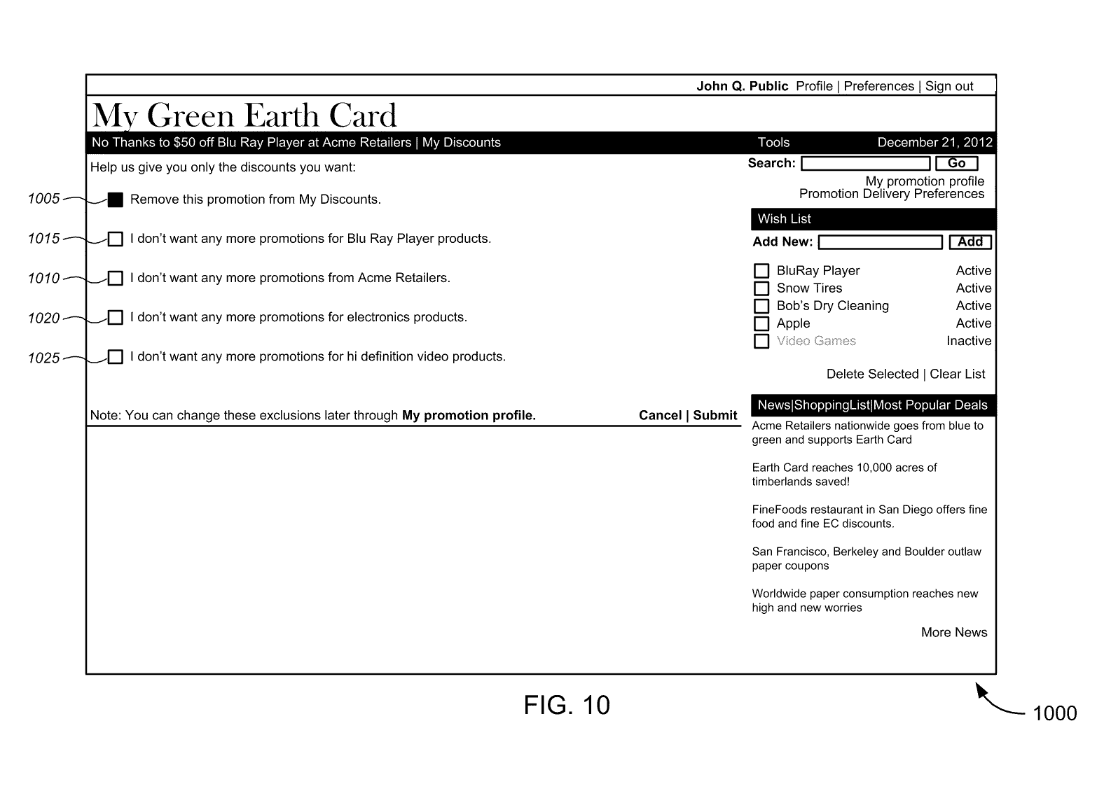

Another way in which certain embodiments allow the consumer to customize the types of items for which the consumer would like to receive offers is by allowing the consumer to use offers already provided to the consumer as a sort of template to evaluate other potential promotional offers. Returning to FIG. 7, for example, a promotional offer (displayed for the consumer as an entry 725 on the list 720 of offers) may have user-selectable interface element 730 (which may be implemented, like other interface elements described herein, as a button, a hyperlink, a checkbox, a combo box, a dropdown list, etc.) to allow the user to indicate that the user would not like to participate in that offer. If the user selects the interface element 730, the system may display for the user a display screen such as the exemplary screen 1000 illustrated by FIG. 10.

The display screen 1000, which, as noted above is invoked when the consumer declines a display promotional offer, can provide options for the consumer to customize his or her user experience, based on the characteristics of the decline the offer. As a simple example, the display screen 1000 includes a user-selectable option 1005 to remove the selected promotional offer from the list of offers that have been identified for the consumer. Additionally and/or alternatively, the display screen 1000 may offer additional options as well. Merely by way of example, the display screen 1000 may include a user-selectable option 1015 to allow the user to provide input indicating that the consumer would not like to receive any further offers from the retailer that provided the selected offer. Further, the display screen 1000 may include other user-selectable options to decline promotional offers with that pertain to similar types of products as the product to which the selected offer pertains. This feature may be offered at varying levels of granularity. Merely by way of example, in the illustrated embodiment, the selected offer pertains to a Blu-Ray player, and the display screen 1000 includes user selectable options (1015, 1020, 1025, respectively) to decline all promotions related to Blu-Ray players, electronic products in general, and/or high-definition video products. Other offer characteristics may also be used to allow the user to in which the users not interested. For instance, in some embodiments, the display screen 1000 might include user selectable options to decline offers with locations similar to the location corresponding to the selected offer, to decline offers with similar discount amounts to the selected offer, and/or the like. It should be noted that, in the illustrated embodiment, the user selectable options are provided with checkboxes but, as indicated above, any other suitable type of interface element can be used to allow the consumer to provide input on display screen 1000.

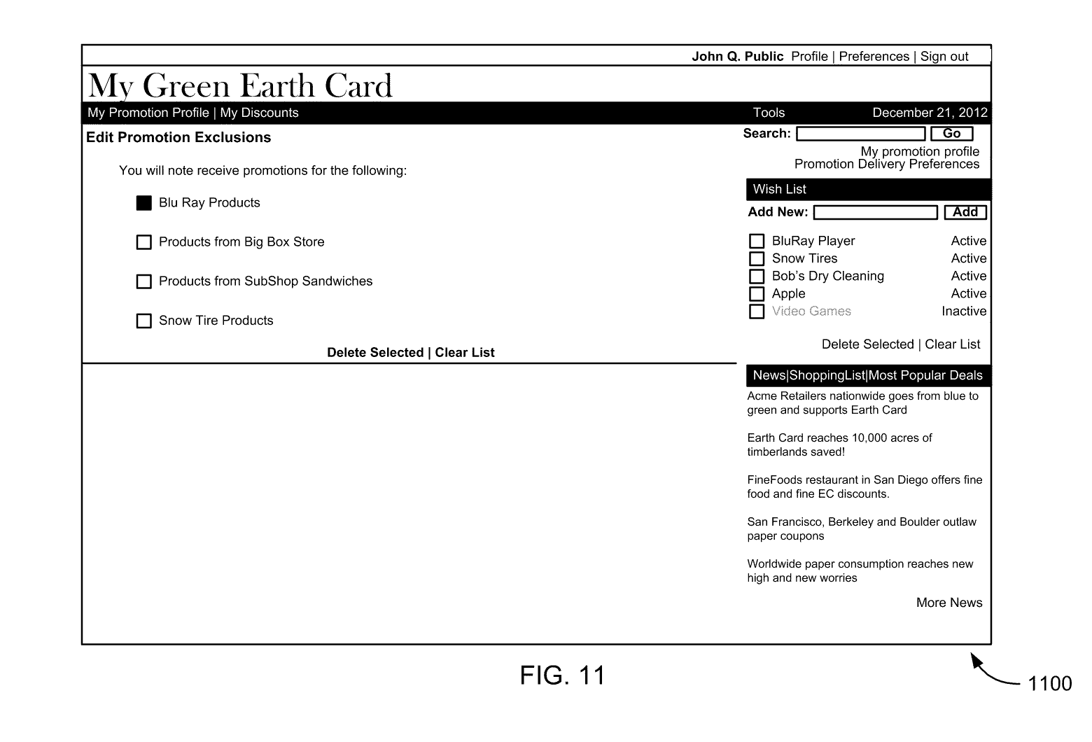

An advantageous feature of some embodiments is the ability to display for the consumer (and/or to allow the user to provide input to edit) the types of promotional offers that the consumer is indicated he/she is not interested in. Hence, for example, in some embodiments, the computer system might provide for the consumer a display screen such as the display screen 1100 illustrated by FIG. 11, which indicates that the consumer has previously indicated that he/she is not etched in receiving promotional offers for Blu-Ray products, products from Wal-Mart, products from Subway sandwiches, or snow tire products.

While not illustrated on FIG. 7, other embodiments feature user interface elements similar to element 730, except that they allow the consumer to indicate to the system that the consumer would like to receive more offers like the displayed offer. Upon receiving input via this element, the system might search the database for other promotional offers available to the consumer with characteristics (such as retailer identity, location, product type, discount amount, etc.) similar to the selected offer. In some cases, the consumer may be provided with a display screen (which may be analogous to the display screen 1000 described above with respect to FIG. 10) for the consumer to provide input about which characteristics of the selected offer the consumer would like the system to attempt to match in searching for other offers.

Although some embodiments of the invention can be used to provide promotional offers for online products, certain embodiments, as noted above, can be used to provide promotional offers for products that are offered for sale at physical (“bricks and mortar”) locations. Hence, in certain embodiments it may be advantageous to allow the consumer to identify preferred locations for the consumer, since promotional offers for products sold near those preferred locations likely will be of more interest to the consumer than offers requiring substantial travel by the consumer. Accordingly, returning to FIG. 6, the method 600, in an embodiment, further includes providing a mechanism for the consumer to identify one or more locations preferred by the consumer, and/or receiving input identifying such locations (block 630).

Merely by way of example, the computer system may provide a mechanism to allow the consumer to provide such input for storage in the consumer's profile. Turning again to FIG. 8, the display screen 800 illustrating the consumer's profile includes a portion for displaying the consumer's preferred locations (collectively, 810). This section includes user interface elements that allow the consumer to add a new preferred location and/or to edit or delete locations that already have been defined (by the consumer or others). For example, in the illustrated embodiment, the “Add New Location” hyperlink provides one mechanism for a user to indicate that he/she would like to provide a preferred address, while the “Edit” hyperlink 820 and “Delete” hyperlink 825, provide a mechanism for the consumer to indicate that he/she would like to edit or delete, respectively, an existing location entry in the consumer's profile. (Of course, as noted above, other embodiments may use different user interface elements to accomplish the same purpose.)

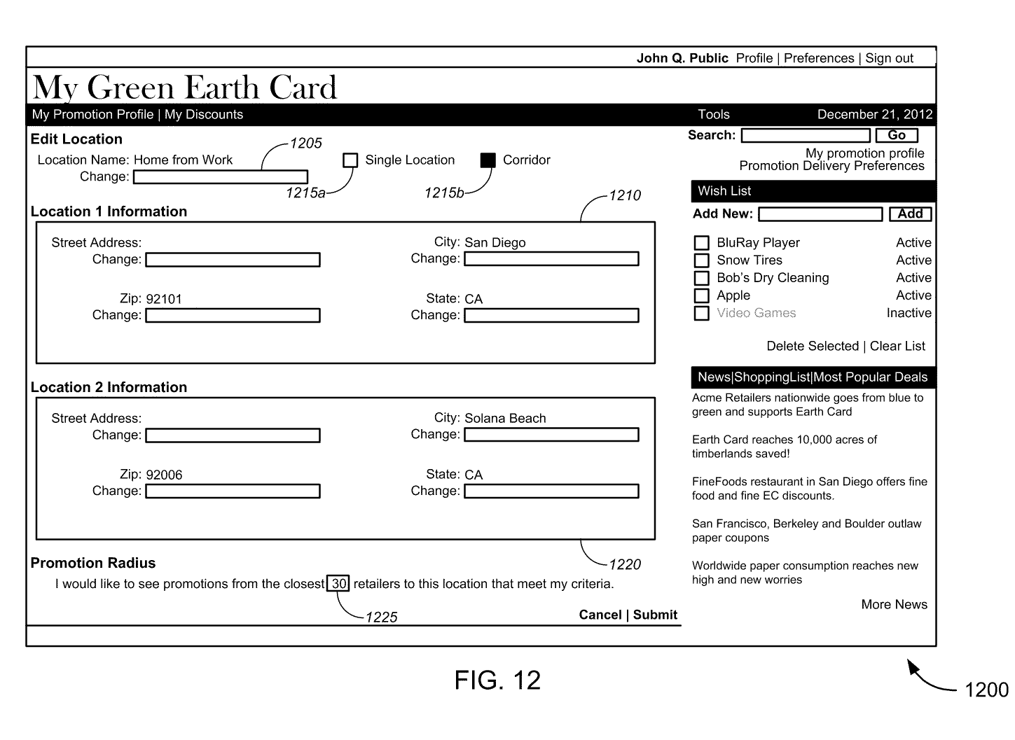

When a consumer indicates that he/she would like to provide an additional preferred location, the computer system, in some embodiments, will display for the user a user interface screen similar to the display screen 1200 of FIG. 12. (The display screen 1200 of the embodiment illustrated by FIG. 12 illustrates a situation in which the consumer has requested to edit an existing preferred location—that is, a location the consumer already has defined as an existing location—and the display screen 1200 accordingly depicts location information that the consumer already has provided, which the consumer may edit on the display screen 1200 if desired. One skilled in the art will appreciate, however, a screen similar to the screen 1200 may be displayed, except in such a case, the location information will not be populated with pre-existing data). Displaying a display screen similar to the screen 1200 (the contents of which may vary by embodiment) provides one example of how the computer system may provide a mechanism for the consumer to identify a location preferred by the consumer.

The display screen 1200 includes a user interface element 1205 with which the consumer can provide a name for the location, as well as a user interface element 1210 (or set of user interface elements, which in this case are text entry fields) for the user to provide an address and/or other identifying location information (such as GPS coordinates, etc.) for a first preferred location. Using these interface element(s) 1210, the consumer can provide, and the computer system can receive, user input identifying a location preferred by the consumer. This preferred location can be used, as described in further detail below, as a criterion in searching for appropriate promotional offers for the consumer.

In some cases, a display screen such as the display screen 1200 is used to receive information about a single location. In other cases, however, a display screen such as the display screen 1200 can be used to receive information about multiple locations, and/or the user can be given a choice about whether he/she desires to provide information about single location or multiple locations on the display screen 1200. Hence, in the illustrated embodiment, the display screen 1200 includes a user interface device 1215a (in the illustrated case, a checkbox) to allow the consumer to indicate that he/she wishes to input information about only single location and/or a user interface element 1215b (which, in the illustrated embodiment is again a checkbox) to allow the consumer indicated he/she wishes to enter information about multiple locations. If the user elects to provide information about multiple locations, another set of input fields 1220 may be provided for the user to provide information about the second location.

In certain embodiments, one piece of information the consumer may be allowed to provide is an offer amount threshold, which may be provided by the consumer through a user interface element, such as the text input field 1225. Using this offer amount threshold, the consumer can limit the display of offers responsive to one of the consumer's search criteria to a number of offers defined by the consumer. Hence, in the illustrated case, if the consumer has indicated that he/she would like to see promotional offers on DVD players, and there are more than thirty such offers, the list of offers displayed for the user (in the fashion described below, for example) would be limited to thirty offers. (Of course, in an aspect, if the user had indicated interest in two different types of products, the displayed list of promotional offers might be limited to thirty offers pertaining to each of the two products, or sixty offers total.)

In a novel aspect of some embodiments, the computer system may consider the two locations together and/or may consider a path between the two locations as a single location. In other words, the path between the two locations may be treated as a corridor, and each point along this corridor can be considered to be a preferred location. This functionality can be useful, for example, if the consumer enters a home address and workplace address, and the user would like to see promotional offers that approximate to the consumer's daily commute between the two locations. (Of course, the consumer could also provide information about two discrete, named, locations on two different instances of the display screen 1200—or a similar display screen—and the computer system could treat the path between those two main locations as a corridor as well.

In accordance with various embodiments, a consumer may be provided with other mechanisms for providing location information. Merely by way of example, if the consumer accesses the system from a location-enabled device, such as a wireless phone or other mobile device with a GPS receiver, the consumer may be offered the opportunity to select the current location of the location-enabled device as a preferred location. As another example, the mechanism for the consumer to identify a preferred location could be a display screen (which might be provided by a separate program, web page, etc.) that illustrates a map, a satellite view of an area, and/or the like, and the user may be given the ability to select (e.g. with the mouse, a stylus, or other pointing device) a location on the displayed image as a preferred location.

Returning now to FIG. 6, the method 600 includes identifying one or more promotional offers (from the plurality of promotional offers in the database) meeting a set of criteria established by the consumer and/or others (block 635). This set of criteria can be based on many factors, including without limitation, the type(s) of products the consumer is interested in receiving offers about, one or more preferred locations, other offer characteristics preferred by the user (such as the amount of discount, the retailer, etc., some or all of which might also be considered in some embodiments as characteristics of the type(s) of products the consumer is interested in receiving promotional offers for), and/or the like. As noted above, these factors can be established through user input from the consumer detailing the consumer's preferences in this regard.

In some cases, identifying the one or more offers that meet the consumer's criteria can include searching the offer database (using standard database search tools, such as SQL searches, and/or proprietary search technologies). As noted above, in an aspect of some embodiments, promotional offers can be stored in the database as a set of records, with each record containing information about the promotional offer, such as the starting and ending dates for the offer, the type of product which the offer pertains, the retailer providing the offer, the location of the retailer providing the offer, and/or the like. Identifying offers meeting the consumer's criteria, then, may involve searching the database for records with fields that match the criteria provided by the consumer. The procedures for identifying offers appropriate for the consumer may be implemented on an as-demanded basis (for example when the consumer presses a “search for offers” button on the user interface) and/or on a continual and/or periodic basis (in which case the consumer may be notified of the offers, as described elsewhere herein).

After identifying one or more promotional offers appropriate for the consumer, the system generates a list of these offers (block 640) and/or, if the consumer is currently online (i.e., interacting with the computer system) displaying a list of the identified offers for the consumer (block 645). Merely by way of example, if the consumer invokes a search of the offer database while online, the list may be displayed for the user immediately. Alternatively and/or additionally, if the promotional offers are identified based on a scheduled search (or any other search conducted while the consumer is not online) the consumer may be notified, and the next time the consumer logs onto the system, the list of identified offers may be displayed for the consumer.

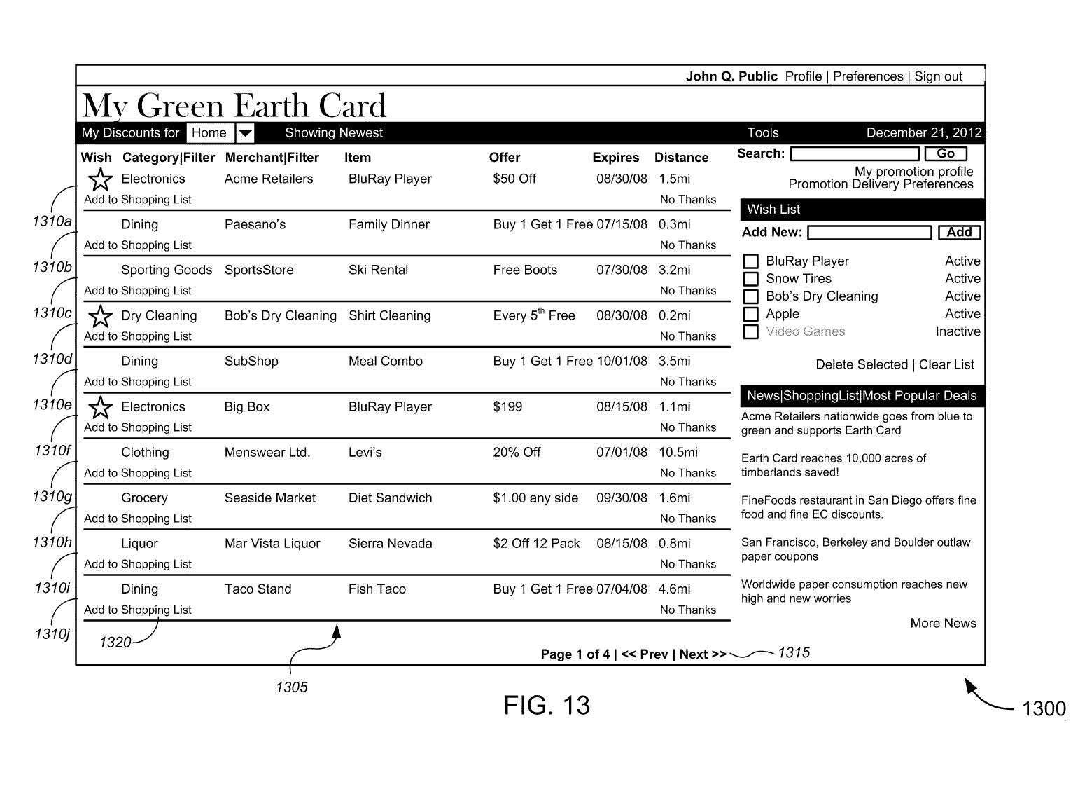

FIG. 13 illustrates an exemplary display screen 1300 that displays a list 1305 of promotional offers 1310 that have been identified as matching the consumer's criteria. While there are many possible ways of displaying the list of identified promotional offers in accordance with various embodiments, the illustrated embodiment displays the list as a matrix or grid comprising a plurality of rows (in this case, one row for each offer) and a plurality of columns, each of which displays a characteristic the promotional offer. In the illustrated embodiment, for example, there is a column indicating whether each promotional offer is responsive to an item on the consumer's wish list, a column describing the product category of each offer, a column describing the merchant from which each offer is available, a column describing the item (or product) which the offer pertains, a column describing the discount or other features of the offer, column describing expiration date of each offer, in a column describing the distance between the location at which the offer may be redeemed (i.e., the physical location of the retailer) and one or more of the consumer's preferred locations. In this way, the consumer can easily see and/or compare information about each of the identified offers. (It should be noted, of course, that if the number of promotional offers identified for the consumer exceeds the display space on a single display screen, multiple screens may be used to display the information, and the consumer can be provided with a mechanism 1315 to navigate between the display screens.)

In a beneficial aspect of some embodiments, the consumer may be provided with tools for managing the displayed list of offers. Hence, returning to FIG. 6, the method 600 may include providing (e.g., via the computer user interface) in mechanism for the consumer to manage the list of the identified promotional offers, and/or receiving (again, e.g., be the computer user interface) user input from the consumer for managing the list of identified promotional offers (block 650). Merely by way of example, the display screen 1300 of FIG. 13 illustrates several such mechanisms. For instance, the display screen 1300 includes a user interface device (in this case, a pull-down list) to allow the consumer to select a location (in the illustrated embodiment, “Home”) to which each of the display offers pertains—the distance in the distance column therefore displays the distance between the offer location and the consumer's specified “Home” location. Further, the display screen 1300 provides user interface elements to allow the consumer to filter the displayed list by one or more columns (e.g., to filter by product category, by merchant, etc.), so that the displayed list includes only offers meeting the filter criteria. In addition, the display screen 1300 can receive user input (for example a mouse click on a column heading) to sort the displayed list (e.g., in ascending order, descending order, etc.) by values in that column. Also, as noted above, each displayed offer may include an interface element (such as the illustrated “No Thanks” hyperlink) to allow the consumer to remove a selected offer from the list of identified promotional offers. Other mechanisms for managing the displayed list of offers are available as well, and the tools described herein should not be considered limiting.

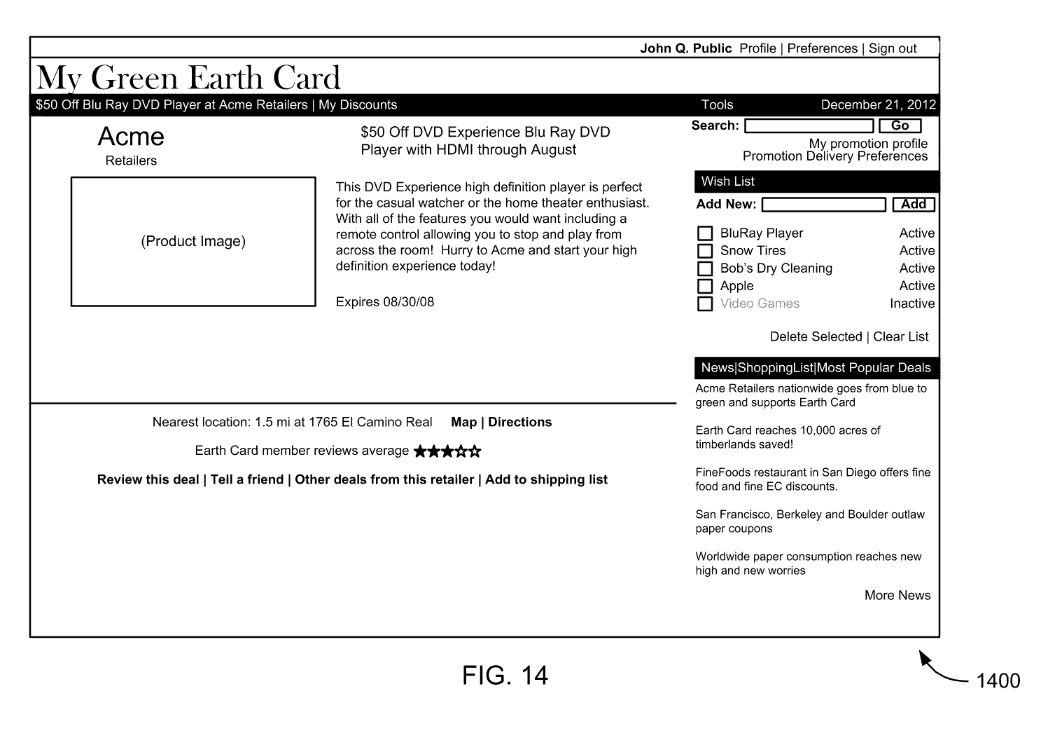

If desired, the consumer can select a promotional offer record for which the consumer would like to view a detailed display of the offer (for example, by clicking with a pointing device on the item to which the offer pertains, such as the hyperlink “BluRay Player” for the offer 1310a in the first row of the list 1305). Upon receiving such user input, the computer system can provide a detailed display of the offer, such as that illustrated by the display screen 1400 of FIG. 14. This detailed display may include some product details about the item to which the offer pertains, photo(s) of the item, and the like; this detailed display may be similar, in some respects, to a promotional offer provided to consumers by more traditional means.

Returning now to FIG. 6, after receiving user input for managing the list, the computer system may redisplay the list according to the consumer's desires, as indicated by the user input (indicated by the broken line between blocks 650 and 645) and/or may in generate and display a revised list of identified offers, based at least in part on the user input received from the consumer (as indicated by the broken line between blocks 650 and 640). Merely by way of example, if the consumer provides input to filter a displayed list by a value in a particular column, the list may be redisplayed to show only the filtered results. By contrast, if the consumer provides input indicating that consumer is not interested in one or more of the display promotional offers, a revised list of offers may be regenerated to exclude the offers in which the consumer has indicated no interest. (It should be noted, however, that the choice between merely redisplaying a list of offers and generating a revised list is discretionary and can vary by implementation.)

The method 600 can further include providing (e.g. via the computer user interface) a mechanism for the consumer to identify promotional offers the consumer desires to receive, and/or receiving user input identifying one or more preferred promotional offers (i.e., promotional offers the consumer desires to receive) (block 655). To illustrate but one example of this technique, the display screen 1300 of FIG. 13 includes, for each of the displayed promotional offers, an interface element to add the offer to the consumer's shopping list (e.g., the hyperlink 1320); this interface element provides a mechanism for the consumer to provide user input to identify a promotional offer the consumer desires to receive. In the illustrated embodiment, adding a promotional offer to the consumer's shopping list indicates that the consumer would like to receive the offer. It should be recognized, of course, that other embodiments might implement other techniques to allow a consumer to indicate interest in a promotional offer. Merely by way of example, in some embodiments, the display screen 1300 might include (e.g., as a column in the list 1305) a checkbox that the consumer could either activate or deactivate to indicate the consumer's interest in receiving the offer.

In a set of embodiments, once a consumer indicates that he/she would like to receive one or more preferred promotional offers (in this context, the term “preferred promotional offer” connotes a promotional offer the consumer has indicated a desire to receive), the computer system delivers the preferred promotional offer(s) to the consumer (block 660). Delivery techniques can vary by implementation and/or by the consumer's preferences, and many delivery techniques are described above—any such delivery technique may be implemented by various embodiments.

In some cases, delivering a preferred promotional offer to a consumer might merely comprise updating either the consumer's profile in the database or the promotional offer record to indicate that the consumer is eligible to participate in the offer. In other cases, however, delivering a promotional offer to the consumer might comprise providing some notification to the consumer about the promotional offer. Hence, one example of delivering a preferred promotional offer to a consumer is to transmit an electronic mail message (and/or an instant message, SMS message, or any other type of communication described above) to the consumer—this message can contain any of a variety of offer details (including, for example, information about the offer, the retailer and/or a location at which the consumer may purchase the offered item). In some cases, delivering the offer might comprise delivering a detailed description of the offer, such as that illustrated by FIG. 14, by electronic mail.

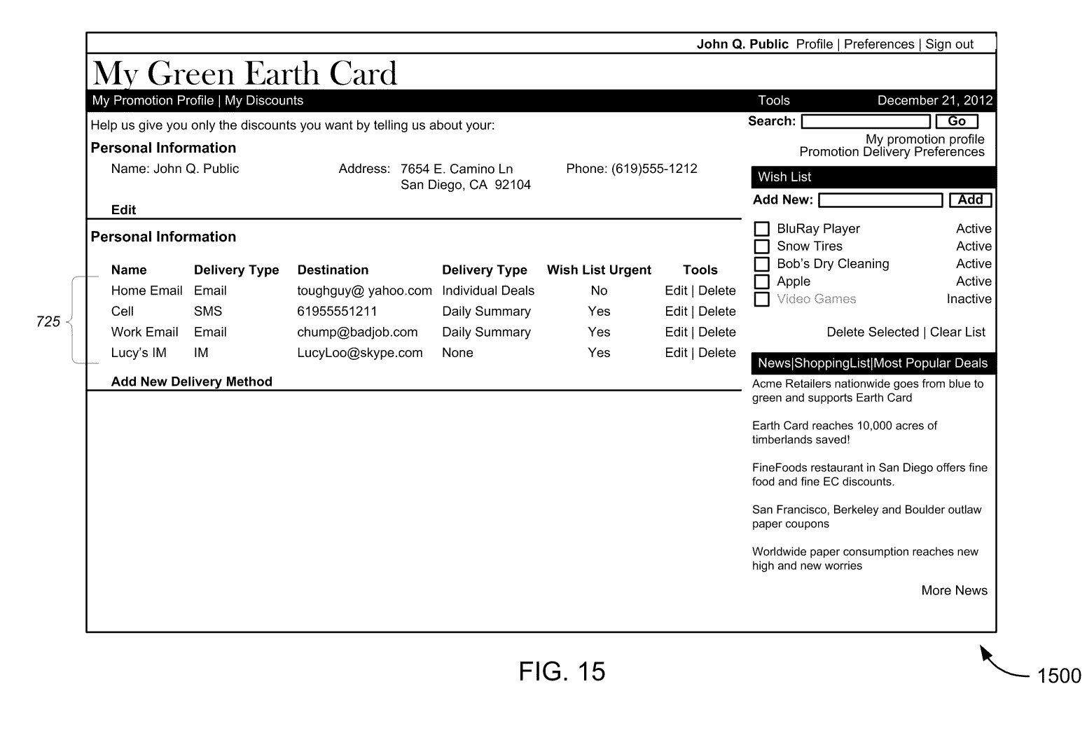

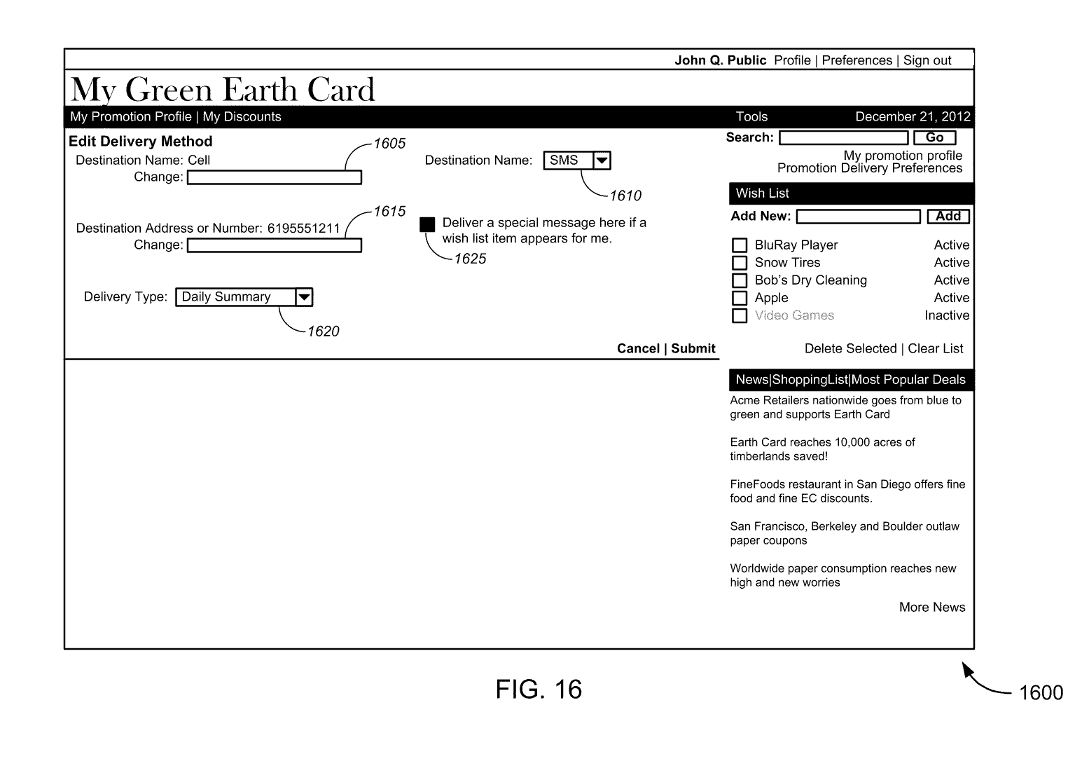

Another advantageous feature of some embodiments is flexibility in offer delivery techniques, and/or the corresponding ability for the consumer to define the techniques by which promotional offers should be delivered. To illustrate one such embodiment, FIG. 15 depicts a user interface display screen 1500 illustrating a set of delivery techniques defined by the consumer, and FIG. 16 depicts a user interface display screen 1600, on which a consumer can provide user input about preferred delivery techniques. Merely by way of example, the display screen 1500 comprises a list 1505 of preferred delivery techniques that the consumer has defined. By reference to FIG. 16, for each such technique, the consumer can provide a name for the delivery technique (using an appropriate interface element 1605), describe a type of delivery (e.g., electronic mail, SMS, IM, etc.) (with interface element 1610), and/or provide a destination address to which the promotional offer should be delivered (with interface element 1615). In some cases, the consumer can also specify whether each preferred promotional offer should be sent in an individual message, or whether a summary message should be sent (and perhaps the frequency at which such summary messages should be sent) with a list of preferred offers (using an interface element 1620). In addition, in some cases, the consumer can specify whether offers pertaining to items on the consumer's wish list (or offers with any other specific characteristics) should be sent with an urgent status (using interface element 1625). (It should be noted as well that, in addition to the offer selection process described above, some or all types of promotional offers, such as those that pertain to a consumer's wish list items, might be automatically considered preferred offers and delivered to the consumer without any selection by the consumer.)

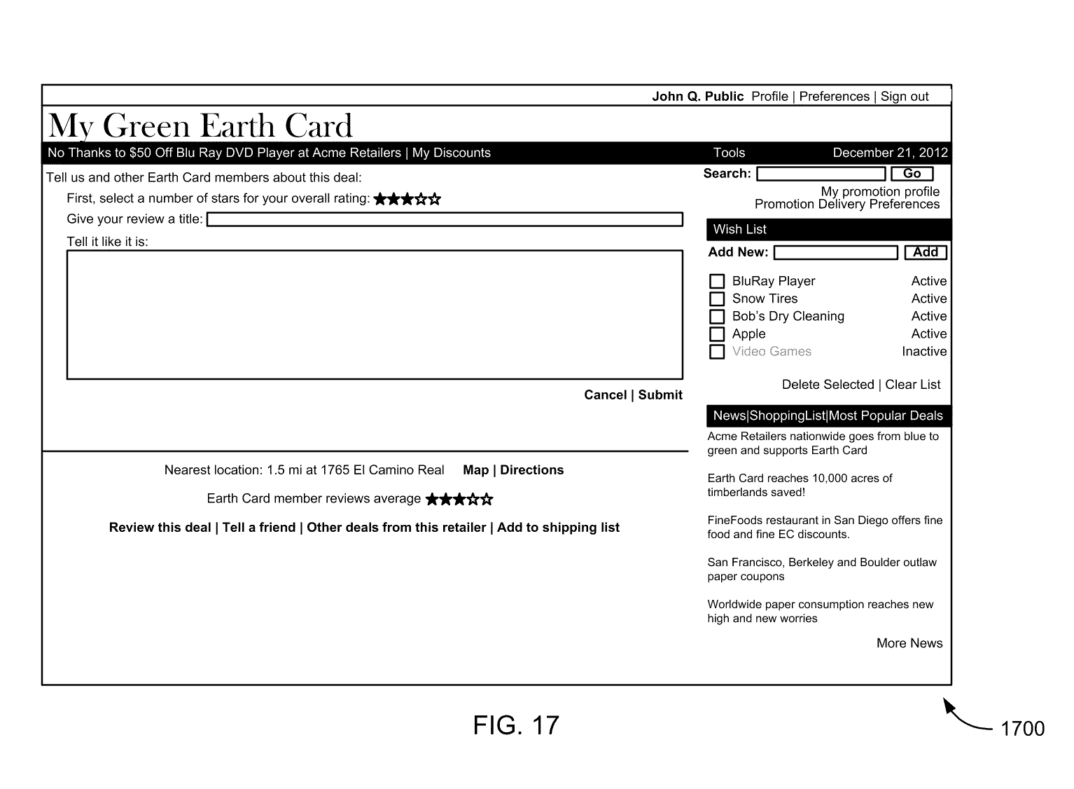

One feature provided by certain embodiments is the ability for consumers to rate various promotional offers. These ratings can pertain to an offer itself, to the retailer providing the offers, and/or to the product(s) to which the offer pertains. Accordingly, some embodiments provide a mechanism for a consumer to provide a review of an offer (block 665). FIG. 17 illustrates a user interface display screen 1700 that provides such a mechanism. Merely by way of example, the consumer might be provided with a mechanism to provide quantitative feedback (e.g., a number of stars), as well as qualitative feedback (e.g., textual comments about the offer, retailer, product, etc.). In some cases, the reviews of several consumers may be compiled and/or (for quantitative reviews, in particular) averaged, and the compiled and/or averaged reviews may be displayed for other consumers (block 670). These review for a particular offer may be displayed by the computer system, for example, in a column in a list of offers (e.g., the list 1305 displayed on FIG. 13) of which the reviewed offer is a part, on a detailed display of the offer (e.g., on the display 1400 of FIG. 14), and/or the like.

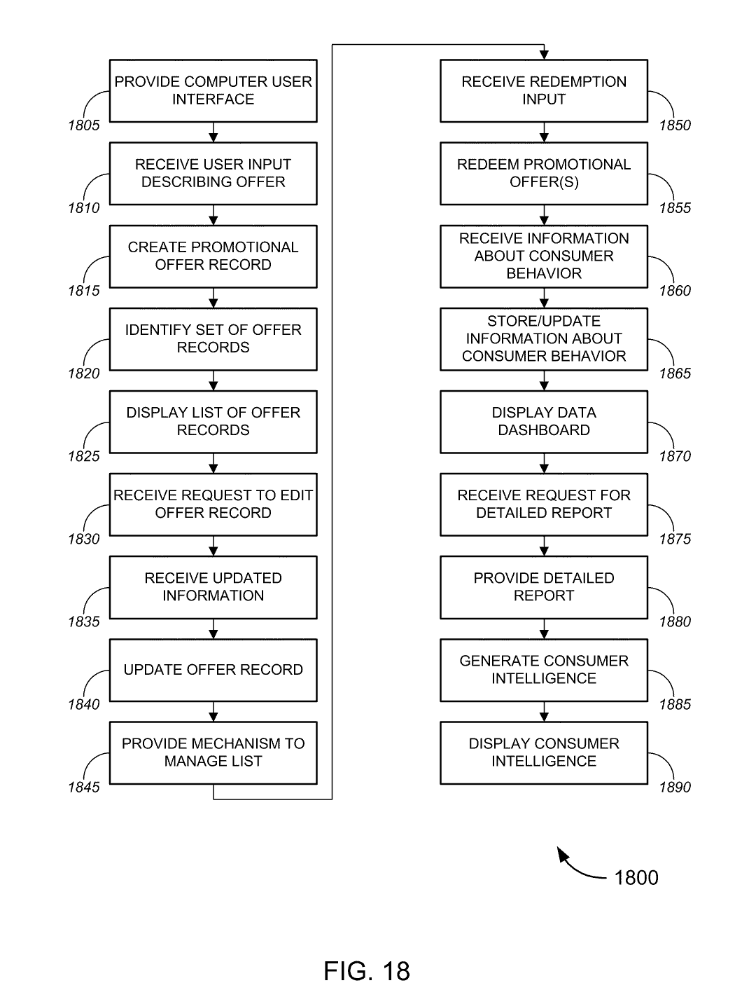

Other embodiments provide flexible and efficient techniques for retailers and other offer promoters to provide promotional offers to consumers, as well as to analyze various metrics associated with those offers (such as acceptance rates, etc.). FIG. 18 illustrates a method 1800 of facilitating the distribution of promotional information for a merchant. The method 1800 comprises providing a computer user interface for interfacing with a user (block 1805). Various computer user interfaces, and procedures for providing such interfaces for interacting with a user, are described above. Any such interfaces and/or techniques may be implemented within the method 1800. In a particular aspect, the computer user interfaces provided in accordance with the method 1800 enable a merchant (or a user associated with a merchant) to interact with the computer system in order to define, manage, analyze, and/or otherwise deal with promotions provided by that retailer, as described in further detail below.

The method 1800 further comprises providing, via the user interface, a mechanism for the user to describe a promotional offer (block 1810), which may be stored as a promotional offer record in a database of promotional offers, as described above. This mechanism may comprise, in some embodiments, one or more user interface elements (such as text entry fields, image upload tools, and/or the like) to allow the user to provide details on a promotional offer that the retailer would like to provide to consumers. Information provided by the user may be used to populate various data fields of the promotional offer record for that promotional offer, as described below.

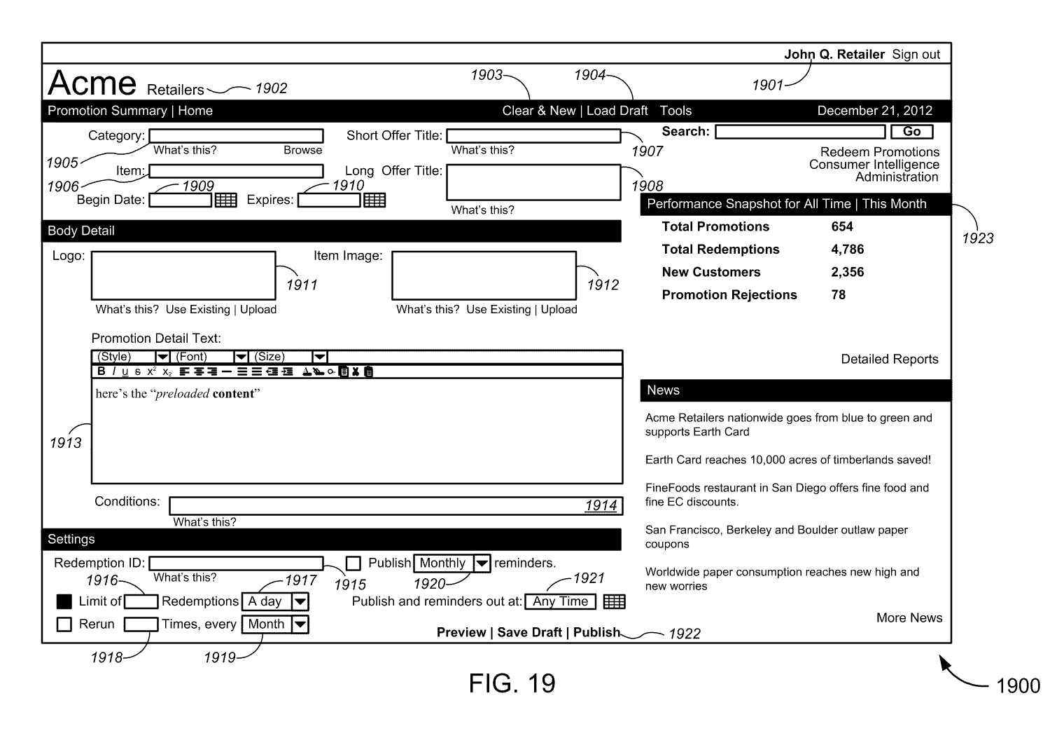

FIG. 19 illustrates an exemplary screen display 1900 that can provide a mechanism for a user to describe a promotional offer. In some instances, the screen display 19000 (like the screen displays 2000, 2100, 2200, and 2300 described below) may be specific to a particular retailer, and the nature of the display (and/or the data and options presented) may be dependent on the retailer with which the user is associated. Hence, the user may be required to login before accessing these displays (and the user's login credentials may be associated with a particular retailer—typically, the user will be an employee or agent of that retailer.)

In the illustrated embodiment, the screen display 1900 includes a variety of user interface elements to allow a user to describe a promotional offer and/or define various parameters associated therewith. The following chart describes the various user interface elements illustrated on FIG. 19, although it should be noted that various embodiments may omit any of these user interface elements and/or include others. (It should be noted that, on FIGS. 19-25, reference numerals are displayed as one- or two-digit numbers enclosed by a circle; this document refers to those reference numerals by prepending the figure number, plus a padding zero when necessary, to the displayed reference numeral. For example, the reference numeral illustrated as an encircled “1” on FIG. 19 is referred to herein as 1901.)

| | Short Title of UI | |
|---|---|---|
| Numeral | Element | Description of UI Element |
| 1904 | Load Draft | Users may save partially completed promotions or ones |
| | | they would like to save and publish later. When clicked, |
| | | a browse box for previously saved drafts will appear. |
| 1905 | Choose Promotion | The user may enter a category for the promotion. I.e. |
| | Category | Dining or any defined category available. If the |
| | | category is manually entered, it is validated against |
| | | those available in the database. If not valid, the user is |
| | | informed, told that they have the option to browse |
| | | categories and returned to this field. When the user hits |
| | | browse, a pop up showing all categories and sub |
| | | categories appear for them to choose one and |
| | | automatically populate the field. This interface will |
| | | include a tree to drill down into sub categories and the |
| | | explanation needed to make the link the same as “what's |
| | | this” below. |
| 1906 | Item Name | The user can enter the item name that will show in the |
| | | “my offers” list defined in the consumer interface as |
| | | defined above. |
| 1907 | Short Offer Title | The user can define a short offer title. This is displayed |
| | | in the offer column of the My Offers list of the |
| | | consumer home page (as illustrated by FIG. 13, for |
| | | example). |
| 1908 | Long Offer Title | This field contains the text that will be the title of the |
| | | promotion detail page as described in the consumer |
| | | interface above. |
| 1909 | Begin Date | This is the date on which the promotion becomes active. |
| | | This is also the date that the notifications are sent to |
| | | participating consumers whose preferences meet the |
| | | criteria of the promotion. Not that the user can select a |
| | | specific time of day to send the promotion on this day, |
| | | as described with respect to reference numeral 1921 |
| | | below. To the right of this field, in the illustrated |
| | | embodiment, is a pop-up calendar control to allow the |
| | | easy choice of a date that populates the field. |
| 1910 | Expiration Date | This is the date the promotion will become inactive. It |
| | | will show on the consumer interface as defined above. |
| | | To the right of this field, in the illustrated embodiment, |
| | | is a pop-up calendar control to allow the easy choice of |
| | | a date that populates the field. |
| 1911 | Logo Insert | This box shows a current retailer logo or allows the |
| | | upload of a new or existing logo. In certain |
| | | embodiments, the system will store previously uploaded |
| | | logos. When the user clicks on the “use existing” link, a |
| | | list of available logos will appear allowing the user to |
| | | choose one that is already stored on the server. This list |
| | | should include a thumbnail of each logo as well. When |
| | | the user clicks on the “Upload” link, an interface is |
| | | provided to allow the user to upload an image file to |
| | | become the logo for this promotion. In some cases, the |
| | | uploaded logos will be resized while retaining their |
| | | current aspect ratio to fit in the space described and |
| | | shown in the promotion detail page in the consumer |
| | | interface. |
| 1912 | Item Image Insert | This box shows a current product image for the product |
| | | to which the promotion pertains and/or allows the |
| | | upload of a new or existing image. In certain |
| | | embodiments, the system will store previously uploaded |
| | | images. When the user clicks on the “use existing” link, |
| | | a list of available images will appear allowing the user |
| | | to choose one that is already stored on the server. This |
| | | list should include a thumbnail of each logo as well. |
| | | When the user clicks on the “Upload” link, an interface |
| | | is provided to allow the user to upload an image file to |
| | | become the logo for this promotion. In some cases, the |
| | | uploaded logos will be resized while retaining their |
| | | current aspect ratio to fit in the space described and |
| | | shown in the promotion detail page in the consumer |
| | | interface. |
| 1913 | Promotion Detail | This window allows the user to enter the body text of |
| | Text Editor | the promotion detail. It allows all standard font |
| | | selection, formatting as shown. In some cases, the |
| | | editor will accept pasting from the user's clipboard and |
| | | retain formatting. |
| 1914 | Promotion | This text will appear at the bottom of the promotion |
| | Conditions | detail page. This could include quantity limits or any |
| | | disclaimers the retailer may want to add. |
| 1915 | Redemption ID | In some cases, a unique identifier is used to identify the |
| | | promotional offer for redemption. This identifier can be |
| | | assigned by the system and/or provided by the user. The |
| | | identifier for the current promotional offer can be |
| | | displayed and/or provided by the user with this field. |
| 1916 | Quantity Limit | This control provides a check box to indicate whether |
| | | there is a limit on the number of items/redemptions a |
| | | consumer can use. If checked, the user can set a |
| | | numerical limit in the first text box. |
| 1917 | Quantity Limit Time | The user selects from a drop down containing the |
| | Period | following time periods after which the redemption count |
| | | will reset. Example values can include “For The Length |
| | | of the Promotion”, “A Day”, “A Week”, “A Month” |
| 1918 | Rerun Promotion | This control provides a check box to indicate whether |
| | | the user would like to set the promotion to repeat as |
| | | defined with different Begin and End Dates. If checked, |
| | | they may enter the number of times they would like it to |
| | | be repeated in the text box. In some cases, the computer |
| | | system will alter the begin date for the period defined |
| | | and will set the end date to be a date the same number of |
| | | days from the rerun date that the original promotion end |
| | | date is from the start date. |
| 1919 | Rerun Period Drop | The user can pick how often the reruns will happen. |
| | Down | Exemplary options are “Week”, “Month”, “60 Days”, |
| | | “90 Days”, “6 months”, “Year” |
| 1920 | Reminders | The user can define periods to send reminder to all |
| | | target consumers. The check box will activate this |
| | | feature. Such reminders can show up as messages in |
| | | the consumer interface described above. |
| 1921 | TOD for Delivery | The user can set the time of day they would like |
| | | consumers to get notifications. |
| 1922 | Preview Promotion | This interface element will cause the computer user |
| | | interface to display promotion detail screen as defined |
| | | in the consumer interface for the user to preview the |
| | | look. The user can save a partially complete |
| | | promotional offer or one the retailer does not want to |
| | | publish yet. The promotional offer then becomes |
| | | available on the Load Draft link as described with |
| | | respect to numeral 1904 above. The user can also select |
| | | a “publish” option, which submits the promotion and |
| | | submits it to the system. The promotion then appears on |
| | | the retailers list. Note that this action will trigger |
| | | consumer offer list updates if the promotion is set to |
| | | start today. |

Returning to FIG. 18, the method 1800 further comprises receiving, via the computer user interface, a set of user input describing a promotional offer (block 1810). This user input can be received, for example, via one or more of the interface elements described above with respect to FIG. 19. Once sufficient user input has been received to describe the promotional offer, a promotional offer record may be created in a database (block 1815). In some cases, the promotional offer identifier (described above) may be used as a key field for the promotional offer record.

The method 1800, in some embodiments, also includes identifying a set of promotional offer records in the database (block 1820). Merely by way of example, in some cases, all promotional offers for a particular retailer may be identified. In other cases, the user may provide search criteria, and only promotional offers meeting those criteria would be identified. (In certain embodiments, irrespective of the search criteria provided by the user, only promotional offers from the retailer with which the user is associated may be identified). The identified promotional offer records then may be displayed, via the user interface, for the user (block 1825).

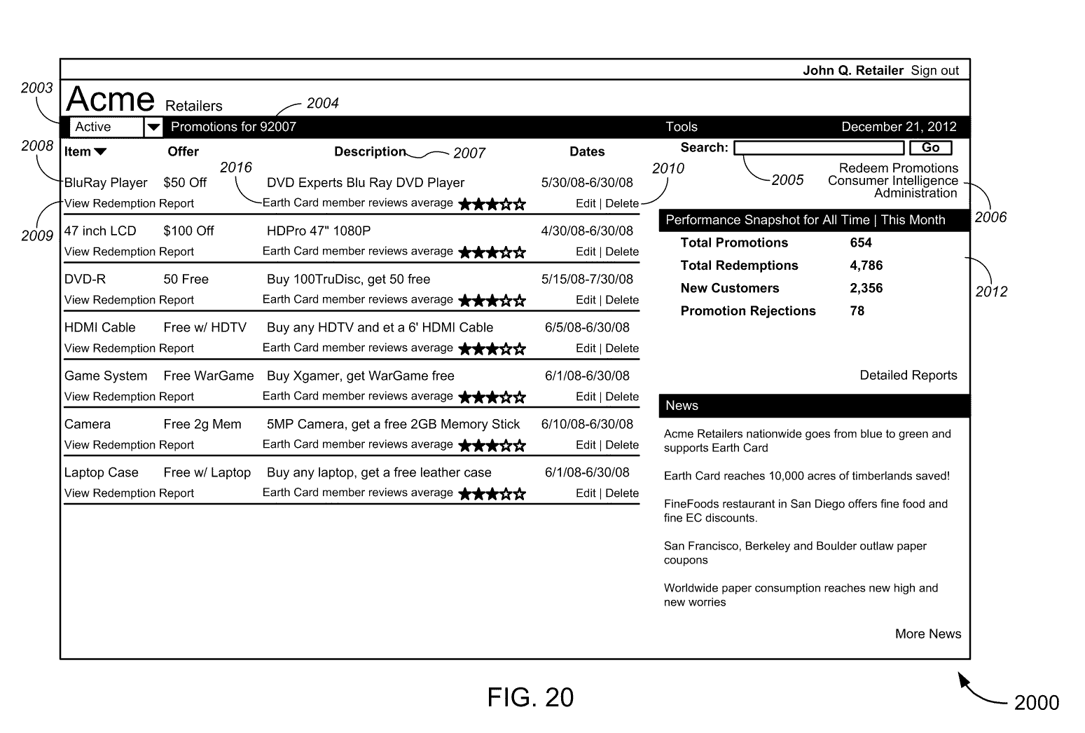

FIG. 20 illustrates an exemplary screen display 2000, in which the computer user interface displays a list of identified promotional offer records. The exemplary display screen 2000 implements a grid layout similar to that described above with respect to the consumer interface, although other display techniques may be used as well. In an embodiment, the computer system provides various option for filtering the offers displayed, such as a user-selectable option 2003 to display only active offers, a user-selectable option 2004 to limit the display to offers only in a particular geographical area (such as a particular ZIP code, etc.) and/or the like. The exemplary display 2000 also includes a user interface element 2005 to allow the user to search for offers meeting specified criteria.

The exemplary screen display 2000 further includes an interface element 2006 that allows the user to access a display of consumer intelligence information (which is described in further detail below), as well as a “performance snapshot” 2012, which provides the user with information on the number of promotions for that particular retailer, as well as the number of offers that have been redeemed, the number of new customers gained through promotions, and the number of rejected offers.

The list of promotional offers, which may be displayed in a grid format as noted above, includes a line for each displayed offer, with a column providing the name of the offer (column 2008), a description of the offer (column 2007), and the active dates of the offer. In addition, the user may be provided with an interface element 2009 to view a redemption report for a particular offer, an interface element 2016 to view customer reviews of the offer and/or the item that is the subject of the offer, and an interface element 2010 to allow the user the option of editing or deleting the offer.

Returning to FIG. 18, the method 1800 further comprises, in some embodiments, receiving a request from the user (for example, via the computer user interface) to edit a promotional offer record (block 1830). This request may be received, for example, by user input in a display screen similar to the exemplary screen display 200 of FIG. 20. Merely by way of example, a user might select the appropriate user interface element 2010 to edit a particular offer record displayed on the display screen 2000. In response to receiving such a request, the computer system may present a user interface screen similar to the exemplary screen display 1900 of FIG. 19, except that the appropriate display fields may be pre-populated with information from the promotional offer record being edited. The user may provide any user input necessary to update the offer record as desired (for example, by modifying information in any of the available user input fields, and then may resubmit the edited offer record to the computer system using an appropriate user interface element. Upon receiving the updated information for the edited promotional offer (block 1835), e.g., via the user interface as described above, the computer system updates the selected promotional offer record (block 1840), for example by replacing and/or modifying the appropriate promotional offer record in the database.

Some embodiments further provide the ability for the user to manage the list of promotional offers for a particular retailer. Accordingly, the method 1800 might comprise providing a mechanism to manage the displayed list of promotional offers (block 1845). Merely by way of example, returning to FIG. 20, as described above, the exemplary screen display provides user interface elements to allow a user to filter displayed promotional offers by active status (element 2003) and/or by location (element 2004), as well as to search for a particular promotional offer (element 2005). Each of these user interface elements can be considered a mechanism for managing the displayed list of offers, and other mechanisms are possible as well. For instance, an interface element might be provided to allow the user to select, to be displayed, promotional offers that meet certain criteria (such as offers that will soon expire, offers for particular products or types of products, etc.). When user input is received via such a mechanism, the computer system might generate a revised list of offers to display and/or might display a revised list of offers, based upon the received user input. This procedure might be similar to the procedures described above with respect to consumer management of displayed lists of promotional offers.

One feature of several embodiments is the ability for a retailer to redeem offers using the computer user interface. Hence, the method 1800, in some embodiments, includes providing, via the computer user interface, a mechanism for retailers to redeem promotional offers. Specifically, in a particular embodiment, the method 1800 includes receiving (e.g., via a computer user interface) user input pertaining to redemption information for one or more promotional offers (block 1850), and/or redeeming one or more promotional offers (block 1855); typically, this redemption is based at least in part on the received user input. As used herein, the term “redeem” means to indicate to the system that a customer has purchased a product that is subject to a promotional offer, and/or to receive, at the computer system, such an indication. There may be additional operations performed by the computer system in response to this indication, such as providing a credit to the consumer, tracking redemption statistics, and/or the like.

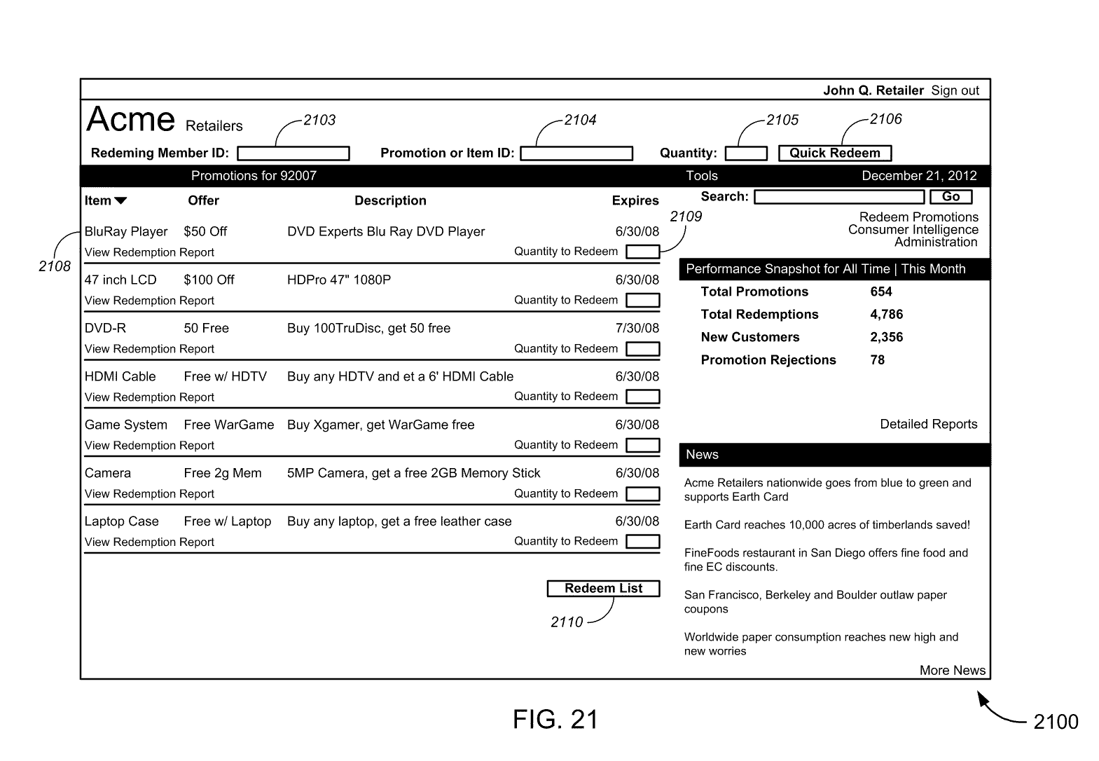

The exemplary screen display 2100 illustrated by FIG. 21 provides an example of a computer user interface that can be used by a user to provide redemption information for one or more promotional offers and/or for requesting redemption of one or more promotional offers. While other redemption techniques are available as well—including redemption via a point of sale device, redemption via a wireless device (as described below), and/or the like—particular embodiments can use an interface such as the screen display 2100 (which might be provided to a user in a variety of ways as described above, such as through a web browser, to name one example) to support retailers who have no other available means of redeeming offers.

The exemplary screen display 2100 provides two different redemption techniques, although other techniques are possible as well. The first provided technique is a “quick redeem” feature, which allows the retailer to provide a retailer identifier in a user interface element 2103, a promotional offer identifier (or product identifier) in user interface element 2104, and a quantity (of offers) to redeem in user interface element 2105. A further user interface element (in this case button 2106) allows the user to submit the “quick redeem” request, at which point, the computer system will receive the redemption information.

The second technique supported by the exemplary screen display 2100 is to display a list of active promotional offers (which may be the same list that is displayed by the exemplary screen display 2000 described above; in fact, the exemplary screen display 2100 of FIG. 21 may be, but need not necessarily be, invoked from the exemplary screen display 2000 of FIG. 20, with the list items displayed on screen 2100 pre-populated, based on the items displayed on the display 2000.) For each item 2108 on the list, the display 2100 provides a user interface element 2109 for the user to provide a quantity of offers to redeem, and another user interface element 2110, when invoked by the user, will submit to the computer system the entire list of redemptions.

A beneficial feature of certain embodiments is the ability for retailers to better understand their customers (and potential customers) through analysis and/or intelligence about consumer behavior in reaction to various promotional offers. For example, one aspect of certain embodiments allows retailers insight into what promotional offers (or items) customers find most interesting. Other embodiments may provide retailers with the ability to provide a retailer with detailed information about consumer reaction to particular promotions, or, alternatively, to all of that retailer's promotions (as evidenced, for example, by consumer behavior with respect to those promotions).

To provide these features, certain embodiments gather and correlate data about consumer behavior. This data can come from many sources, including without limitation consumer interaction with the computer system (for example, the interactions described above with respect to FIGS. 6-17), such as consumer wish lists and searches, consumer shopping lists and/or the like. (It should be appreciated of course, that certain embodiments include safeguards to prevent unauthorized disclosure of consumer information—merely by way of example, retailers may be provided with only aggregated information about consumer interactions, rather than consumer-specific information. In fact, in particular embodiments, the data about consumer information may be tracked only at an aggregate level; in other embodiments, specific consumer interactions may be tracked, but may be provided to participating retailers only in the aggregate). In addition, redemption information for a retailer's promotions (which may be obtained through the redemption process described above) may also be used as a source of information. Other sources of consumer behavior information may be used as well.

The method 1800, therefore, may include receiving and/or obtaining information about consumer behavior with respect to one or more offers (block 1860). This information may be stored in the database and/or updated as new information is received (block 1865). This information, then, can be used to provide participating retailers with information about consumer behavior with respect to various promotional offers—this information can assist retailers in determining which types of offers are most effective, for which items consumers seek promotional offers (or seek to purchase), and/or the like.

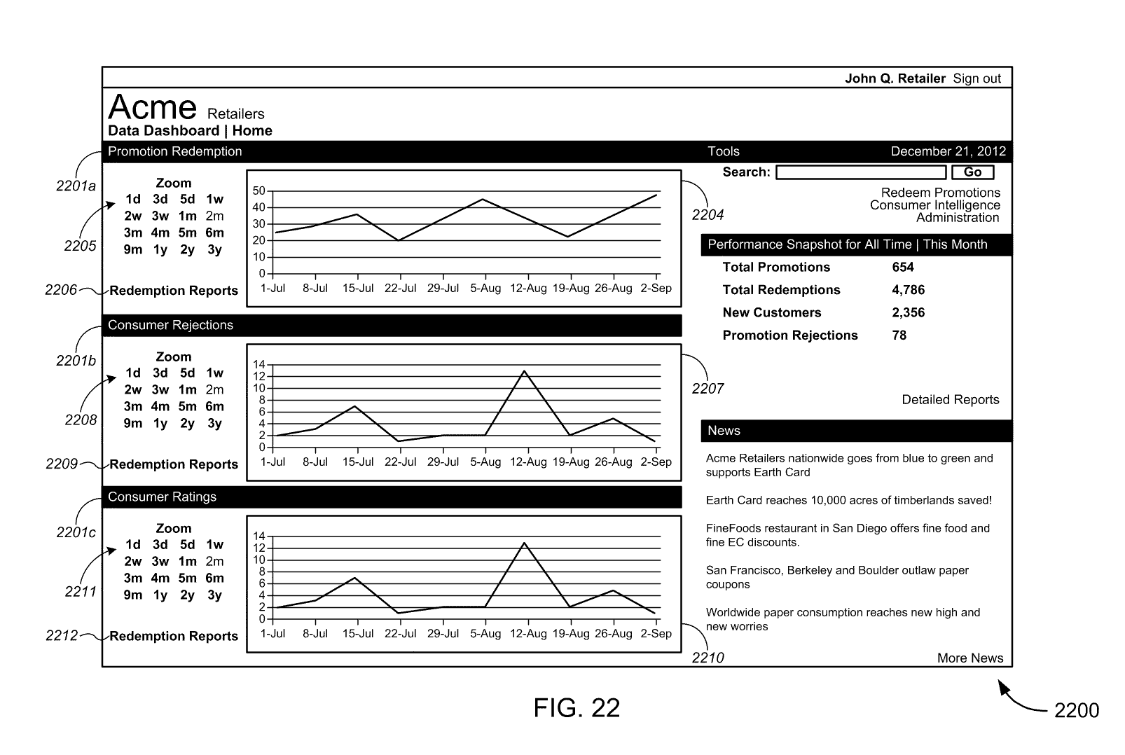

One technique for providing a retailer with information about consumer behavior regarding that retailer's promotional offers a is a “data dashboard.” Accordingly, in an embodiment, the method 1800 comprises displaying (e.g., via a computer user interface), a data dashboard to allow the user to review information about consumer reactions to a retailer's promotional offers (block 1870). Merely by way of example, FIG. 22 illustrates an exemplary screen display that provides a data dashboard 2200 in accordance with one set of embodiments.

The illustrated data dashboard 2200 provides three modules, in the form of panes 2201a-c for displaying information about different types of consumer behavior. The first pane 2201a displays information about consumer redemptions of promotional offers, while the second pane 2201b displays information about consumer rejections of promotional offers, and the third pane 2201c displays information about consumer ratings of promotional offers. It should be appreciated that these panes are exemplary in nature, and that the data dashboard 2200 can be configured, in various embodiments, to display more or fewer panes (or even to forego the use of panes in favor of another display paradigm), and/or to display different types of information than the information displayed by the exemplary dashboard 2200 of FIG. 22.

The first pane 2201a provides a graphical illustration 2204 showing the number of offers redeemed over a given period. Optionally, the computer system may provide the user with interface elements 2205 to select the period over which the redemption statistics should be displayed (exemplary periods include the most recent one day, three days, five days, one week, two weeks, three weeks, one month, two months, three months, four months, five months, six months, nine months, one year, two years, three years, etc., and/or might include other periods than the most recent period, such as a given two month period in the past, etc.). The first pane 2201a also includes a user interface element 2206 that can be selected by the user to generate (and/or display) one or more redemption reports, which might provide additional detail and/or alternative displays of the redemption data (such as tabulated data, pie charts or other graphical displays, etc.).

In some cases (as in the illustrated embodiment), the data dashboard 2200 may include second pane 2201b that provides a graphical illustration 2207 showing consumer rejection information (e.g., the number of promotional offers rejected by customers) over a given period. The displayed information may correspond, for example, to the number of times consumers have rejected any of the retailer's promotions, or the number of times consumers have rejected a selected one or more of the retailer's promotions. The data second pane 2201b may also include as a user interface element 2208, which allow the user to specify the desired period for the graphical illustration 2207, and/or a user interface element 2209 allow the user to request the generation and/or display of one or more reports of consumer rejection information. These reports may be similar to the redemption reports described above. Likewise, the operation of interface elements 2208 and 2209 may be similar to the operation of corresponding elements 2205 and 2206 described above.

In some embodiments, the data dashboard 2200 may also include a third pane 2201c that provides a graphical display 2210 of average consumer ratings of all (or of a selected one or more) promotions offered by the retailer. Like the first two panes 2201a and b described above, the third pane 2201c may be customized using a user interface element 2211 to specify a period for which data should be displayed, and reports may be generated and/or displayed by invoking another user interface element 2212.

In some cases, a retailer might wish to review data at a greater level of detail than that offered by the data dashboard 2200. Accordingly, in certain embodiments, the computer system can be configured to provide a retailer with detailed reports on consumer reaction to that retailer's promotional offer(s). In one aspect, a detailed report might provide data about all of a retailer's promotional offers; in another aspect, a detailed report might provide data about one or more promotional offers (e.g., a set of one or more promotional offers selected by the user.) The method 1800, then, may comprise receiving (e.g., via the computer user interface) user input comprising a request to view a detailed report about consumer behavior with respect to one or more of the retailer's promotional offers (block 1875).

Typically, in order to receive such user input, the computer system will provide a mechanism for such input. Merely by way of example, the data dashboard 2200 of FIG. 22 provides user interface elements to allow a user to request the display of redemption reports (element 2206), rejection reports (element 2209) and/or ratings reports (element 2212). In a particular embodiment, these user interface elements may be configured to request a detailed report having a scope (e.g., promotional offers and/or time period) similar to that of the data displayed in the respective graphical illustration of the data dashboard.

The method 1800, then, might include providing the requested detailed report (block 1880). In some cases, providing the requested report might comprise printing a hard copy of the report. In other cases, the report might be provided via any of the communication facilities described above (such as via email, etc.) and/or exporting the report in a desired format (PDF, XML, spreadsheet format, word processing format, etc.). In a particular aspect, providing the requested report comprises displaying the requested report with the computer user interface.

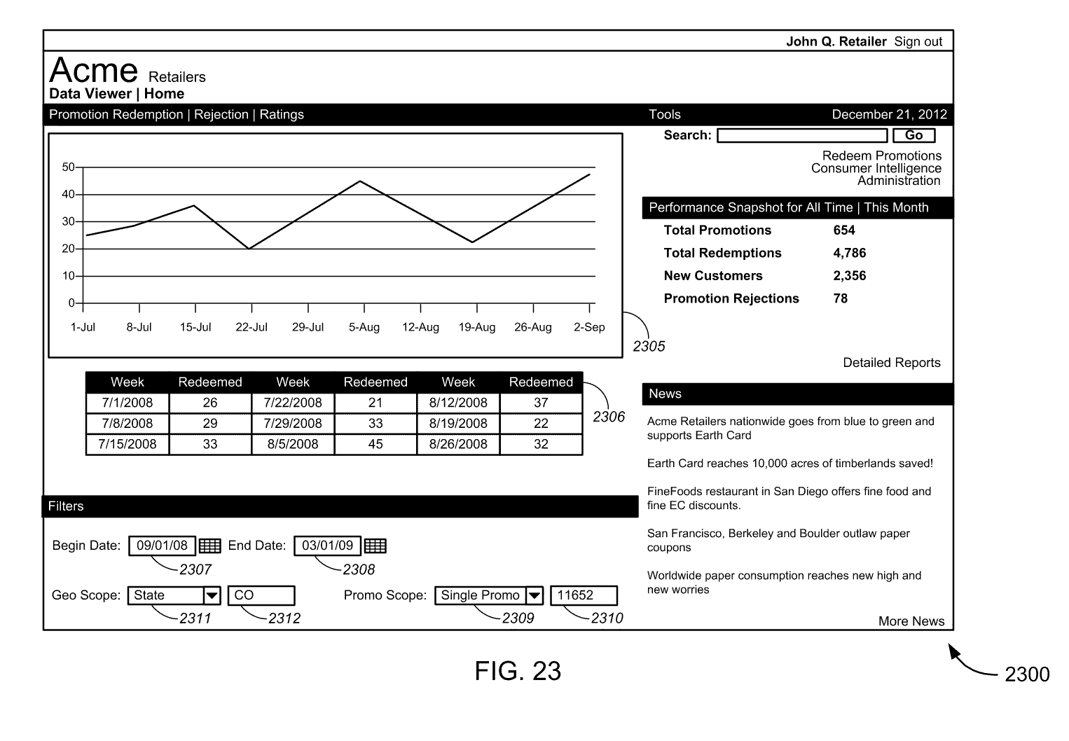

Merely by way of example, FIG. 23 illustrates an exemplary screen display 2300 that provides a detailed report of promotion redemption data. (Similarly, other reports might display other data, such as offer rejection data, consumer ratings data, and/or the like). The detailed report includes a graphical display 2305 (which might be similar to the data dashboard's graphical display 2204 of promotional data, as described above), as well as a tabular display 2206 showing detailed redemption data. In the illustrated embodiment, the tabular display shows a number of promotional offers redeemed by week over six weeks. In aspects of certain embodiments, however, the nature of the tabular display 2206 (and/or the graphical illustration 2305) can be changed.

Merely by way of example, as illustrated by the exemplary screen display 2300, the computer user interface might include one or more user interface elements for customizing the report. In the illustrated embodiment, the user interface includes a user interface element 2307 for receiving user input specifying a beginning date for the reporting period for the report and a user interface element 2308 for receiving user input specifying an end date for the reporting period. The illustrated embodiment also allows the user to provide input specifying the scope of the report, in terms of the offers to include: a user interface element 2009 receives user input specifying a scope of the report; possible options can include, inter alia, a single promotion, all promotions, or some subset of all promotions, such as all promotions of a certain type (e.g., promotions for a certain type of product, a certain type of offer, such as a particular discount amount, etc.), all promotions of a certain status (active, expired, etc.), and/or the like. If the scope of the report is limited using the interface element 2309, another user interface element 2310 can be provided for receiving, from the user, filter criteria (such as a promotion number or set of promotion numbers, a promotion type value, a promotion status value, and/or the like.

Additionally and/or alternatively, the report can be limited in geographic scope. For example, the exemplary screen display 2300 includes a user interface element 2311 for receiving input specifying a geographic scope for the report. Possible geographic scopes can include a particular retailer location, a particular jurisdiction (city, state, country, etc.), a particular ZIP code and/or area code, and/or the like. Another user interface element 2312 can be provided for receiving user input specific a filter criteria (such as a particular retailer location identifier, a particular city and/or state, a particular ZIP/area code, etc.).

Various embodiments can provide a number of different detailed reports. As noted above, reports about consumer redemptions (which may include data collected in the redemption process), reports about consumer rejection of promotional offers and/or consumer ratings of promotional offers and/or items (each of which may include, inter alia, data collected from consumer interactions with the computer system) are a few examples. Additional examples can include, without limitation, a loyalty duration report, which can display data about how long consumers have been loyal customers (based on offer acceptance and/or redemption, etc.), deviation reports (which can provide data on consumer behavior that varies statistically from normal behavior, such as higher-than-expected redemptions of particular offers, higher-than-expected rejections of particular offers, notification type reports, which provide data on redemption and/or rejection of promotional offers based on the offer notification technique, return-on-investment reports, which can provide data comparing sales on particular promotional offers to the retailer cost of providing those offers through the computer system, notification preferences reports, which provide data on consumer preferences for notification techniques, optimum promotion time reports, which provide analytical support for determining an optimum offer duration, based on aging data for consumer redemptions and/or rejections of past offers, campaign comparison reports, which provide comparative data on consumer redemption and/or rejection of two different promotional offer campaigns. Summary versions of each of these reports may be provided on the data dashboard; in some cases, a user interface mechanism may be provided to allow the user to add or delete panes from the data dashboard as desired. It should be noted that other types of detailed reports may be provided by different embodiments.

Another feature provided by some embodiments is the ability for a retailer to obtain consumer intelligence based on system-wide information (i.e., information that is not limited to a particular retailer), in particular information obtained from consumer profiles, such as geographic and/or demographic information about the consumers. (Once again, it should be noted that such information may be provided merely in the aggregate, without revealing to a retailer information about any particular consumer) Merely by way of example, some embodiments may be configured to provide a retailer with intelligence on promotion marked potential, i.e., the number of consumers participating in the system that would be reached by a proposed promotional offer (based on consumer preferences related to the item that is the subject of the offer, consumer demographic and/or geographic information compared to the geographic location of the offer, and/or the like). Retailers may also be provided with information that correlates consumer interest in particular product categories with demographic and/or geographic information about the consumers. Similarly, consumer intelligence correlating items on consumer wish lists (and/or shopping lists) with various geographic and/or demographic information about consumers may be provided. Other types of consumer intelligence may be provided as well.

Accordingly, the method 1800 includes, in certain embodiments, generating consumer intelligence (block 1885). In an aspect, generating consumer intelligence comprises receiving a request for a particular type of consumer intelligence from a retailer (perhaps via a computer user interface) and mining stored data about consumer behavior and/or consumer geographic/demographic information. Generating consumer intelligence can further include correlating a particular aspect of consumer behavior (such as wish list entries, redemption information, etc.) with one or more aspects of consumer demographic/geographic information and/or aggregating this correlated data.

The method 1800, then, may further include providing the consumer intelligence to the requesting retailer (block 1890). The consumer intelligence may be provided using any of the communication techniques described above. In a particular aspect of some embodiments, consumer intelligence may be provided in the form of a dashboard module and/or detailed report, as described above.

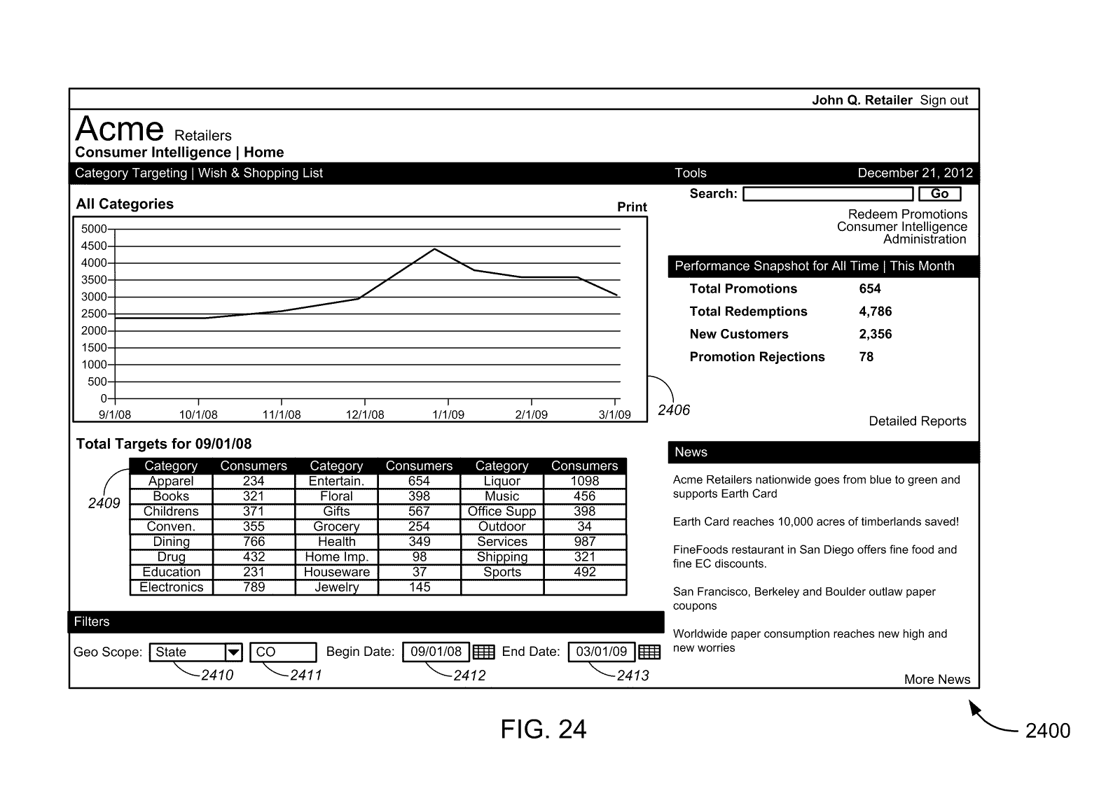

To illustrate, FIG. 24 shows an exemplary display screen 2400 that provides a detailed report on consumer intelligence on the number of potential consumers for a variety of product categories, based on consumer indications of interest. The display screen 2400 includes a graphical display 2406 of overall customer interest (across all product categories) in a specified time frame, along with tabulated data 2409 showing the number of customers interested in each particular product category at a particular point in time.

The display 2400 includes user interface elements to receive user input for customizing the display of consumer intelligence. For example, a set of interface elements 2410 and 2411 allows the user to specify a geographic scope and provide a filter criterion for the scope, respectively, while another set of interface elements 2412 and 2413 allows the user to provide input to limit the durational scope of the inquiry. Based on input received by these user interface elements 2410-13, the consumer intelligence may be re-gathered (if necessary), and the report updated to conform to the scope limitations specified by the user.

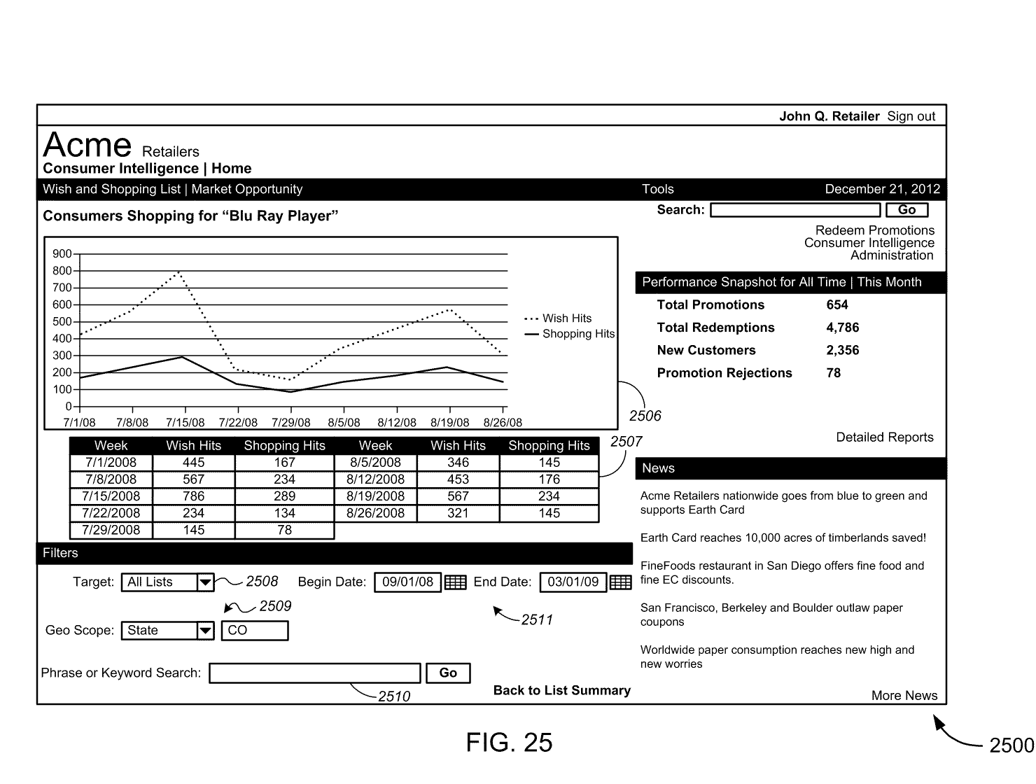

FIG. 25 illustrates another exemplary display screen 2500 that displays a report on consumer wish list and shopping list behavior. As displayed, the report is configured to display information on how many users (over a given period) have included the term “Blu Ray Player” in their wish lists and/or shopping lists. A graphical display 2506 illustrates this data graphically, while a tabular display 2507 displays the same data numerically. Once again, the display screen provides user interface elements to receive user input for modifying the report. For example, a user interface element 2508 may be provided to allow the user to select a type of behavior to analyze (e.g., item on wish list, item on shopping list, etc.), a set of user interface elements 2511 to specify a period of interest, a set of user interface elements 2509 (similar to those described above) for limiting the geographic scope of the inquiry, and a user interface element 2510 for providing input identifying the type of promotional offer or item for which consumer intelligence is desired. Based on input received by these user interface elements 2508-10, the consumer intelligence may be re-gathered (if necessary), and the report updated to conform to the scope limitations specified by the user. (It is worth noting that, in the illustrated example, the same screen display may be used (perhaps iteratively) for receiving a request for consumer intelligence and for displaying the intelligence.

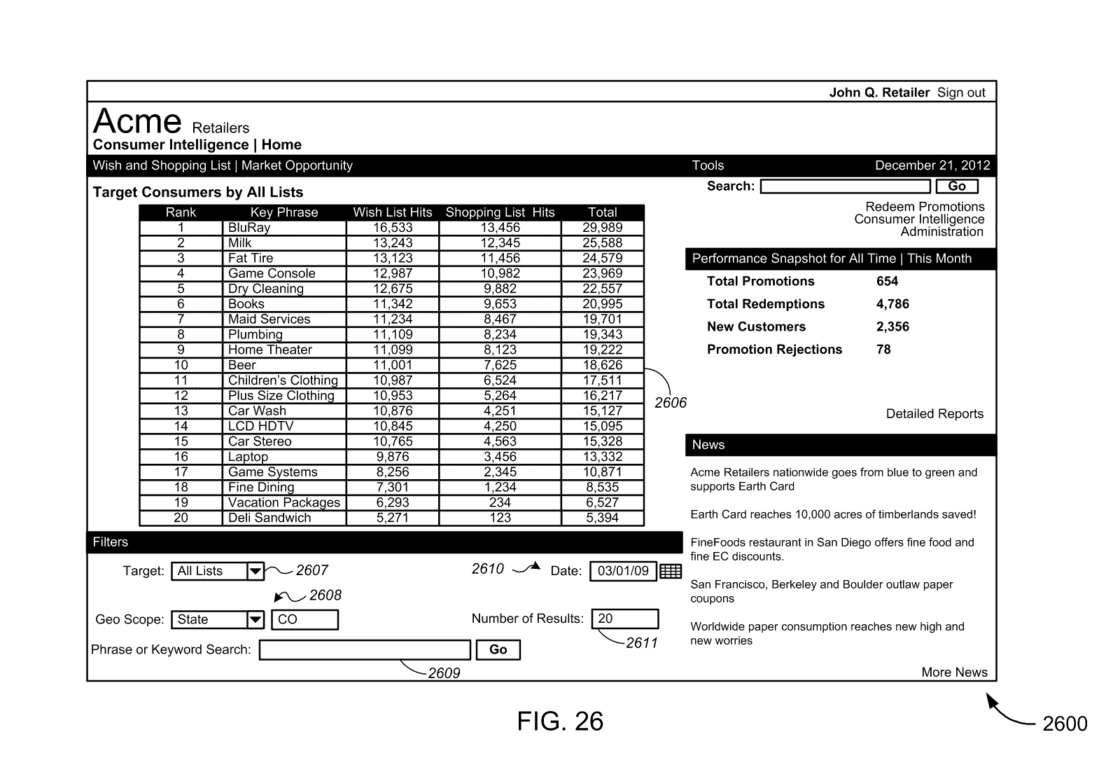

FIG. 26 provides yet another example of a display screen 2600 that can be used to provide consumer intelligence to a retailer. This display screen 2600 provides a report comprising tabular data 2606 about the most targeted (by consumers) promotional offers, items and/or search phrases, ranked by frequency. The data includes information about the offer, item and/or phrase, as well as the number of wish lists and/or the number of shopping lists (and/or a combination of both) on which the offer, item, and/or phrase appears. Once again, this data may be customized by user input received via user interface elements 2607-2610 similar to those described above, as well as a user interface element 2611 for receiving input on the number of results (in terms of search phrases) to return. Based on input received by these user interface elements 2607-2611, the consumer intelligence may be re-gathered (if necessary), and the report updated to conform to the scope limitations specified by the user.

As noted above, a feature of particular embodiments is the ability of the computer system to interact with users (either consumers or retailers) using a variety of communication techniques. In particular, a mobile device (e.g., laptop computer, wireless phone, PDA, or any other wireless device, etc.) may be used to provide communication with users. Virtually any of the communications described above may be performed via a mobile device, including in particular searching for promotional offers, adding items to wish lists and/or shopping lists, and viewing the details of promotional offers (for consumers); redeeming promotional offers, creating viewing and/or editing promotional offers, viewing a data dashboard and/or a detailed report, and/or requesting and/or viewing consumer intelligence (for retailers); and authenticating with the computer system (for both consumers and retailers). In some cases the mobile interface may be provided by a dedicated client program installed on the mobile device. In other cases, the mobile interface may be provided through a web browser installed on the wireless device, in which case, the computer system may be configured (using techniques known in the art) to recognize that a user is interacting with the computer system from a mobile browser and to format served web pages accordingly.

Users interacting with the computer system via a mobile device may also be offered additional functionality, depending on whether that functionality is supported by the mobile device. For instance, the consumer interface may include various location-based enhancements. Merely by way of example, when using a location-aware mobile device (e.g., a device with a GPS receiver, etc.), the user may be provided with the option of using the device's current location as a preferred location (as described above), based on location data provided by the mobile device. Alternatively and/or additionally, when performing a search for promotional offers, rather than specifying a preferred location, the user may be given the option to simply use the current location (as provided by the mobile device) as a search criteria. (In fact, there may be a user interface element that allows the user to specify that the current location specified by the mobile device should be provided as a default location when searching for offers; this preference may be stored in the consumer's profile.) Additionally, the mobile interface may provide the user with a user interface element (such as a hyperlink) that may be selected to invoke a display of a map (and/or directions) from the mobile device's current location to a retail location at which the offer may be redeemed (a third party service may be used to provide this information, as is known in the art).

A particular set of embodiments can be used to provide and/or support cross-promotional services. In some such embodiments, the tools and techniques described above for defining, managing, and/or analyzing promotions, and/or for gathering consumer intelligence may similarly be used to perform such operations for cross-promotions. Merely by way of example, as described above, a promotion typically will pertain to one or more products sold by a particular merchant; a cross-promotion is a promotion that pertains to two or more products. In many cases, a cross-promotion will pertain to multiple products provided by multiple merchants (although this is not required) and might provide an incentive, using one product (or set of products), for a consumer to purchase another product (or set of products). Merely by way of example, a tire reseller and a service station might agree on a cross-promotional offer in which a consumer who buys a set of tires from the tire reseller receives a discount on gasoline purchased from the service station.

Typically, a cross-promotion will benefit each of the participating merchants in the form of increased sales. The cross-promotion arrangement, however, might include additional terms, such as a payment from one merchant to another (for example, to subsidize a discount offered by the second merchant), and/or the like. For instance, in the example above, if the service station offers fifty gallons of free gasoline to consumers who purchase a set of tires from the tire reseller, the tire reseller might agree to reimburse the service station for some portion (perhaps half) of the cost of the gasoline offered to the consumer.

Typically, cross-promotions have been difficult to administer. As a threshold matter, many merchants fail to consider employing cross-promotions to enhance sales, and even those that consider the matter may have difficulty in finding another merchant who might also be interested in participating. Further, many merchants lack sufficient information to make an educated decision about which other merchants might be suitable cross-promotion partners. For example, a cross-promotion involving two products with a common consumer base is more likely to find success than one pertaining to two products with dissimilar markets. Moreover, a merchant may have difficulty determining whether a cross-promotion is an effective use of that merchant's resources.

The tools provided by certain embodiments are well-suited to assist merchants with developing effective cross-promotions. As noted above, certain embodiments provide greatly-enhanced insight into consumer behavior, while other embodiments assist a wide variety of merchants in developing cross-promotions. This combination can provide a highly-effective tool for merchants to find cross-promotion partners, develop cross-promotions, and evaluate the effectiveness of those cross-promotions.

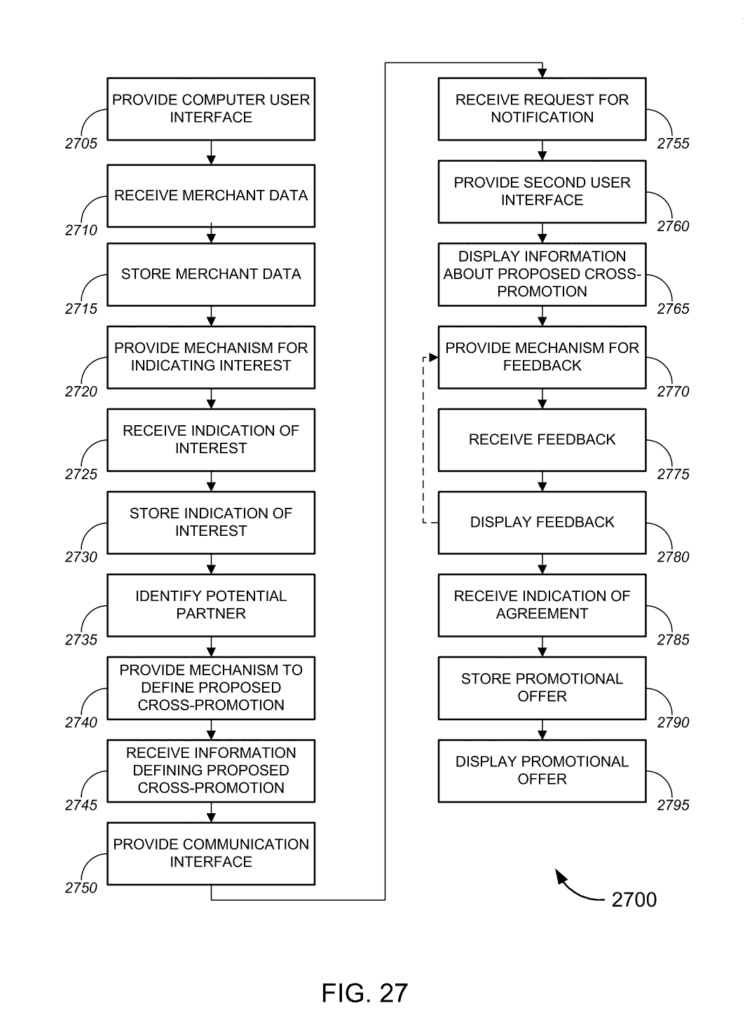

Merely by way of example, FIG. 27 illustrates a method 2700 of providing cross-promotional services. In some cases, the cross-promotional services facilitate a cross-promotion between two or more merchants. (For ease of description, the merchants are referred to herein as a “first merchant” and a “second merchant,” but it should be appreciated that these designations (and all such nominative designations herein) are intended only to distinguish between two or more similar entities and are not meant to limit the roles of any such entities or the functionality of the tools and techniques described herein.) The method 2700 might comprise providing a computer user interface for interacting with a user (block 2705); in an aspect, the user may be associated with a first merchant. Several such user interfaces are described above, and similar interfaces may be used in accordance with the method 2700.

The method 2700, in accordance with a set of embodiments, further comprises receiving, from a merchant, a set of merchant registration data (block 2705). In an aspect, the computer user interface might include a mechanism (such as a display screen in a web browser corresponding to an HTML form, to name an example) to allow the merchant to register to participate in promotional programs, and this mechanism might provide input fields for such data. The merchant registration data can include, without limitation, the name of the merchant, one or more addresses of the merchant (e.g., a corporate address, addresses of one or more retail locations, etc.), a logo or trademark of the merchant, a business type of the merchant (e.g., a grocery retailer, a discount store, an electronics store, a service station, etc.), a market radius for the merchant and/or each location (e.g., an area that the merchant considers to be its primary geographic market), a list of products and/or product categories sold by the merchant, and/or a list of promotions developed by the merchant, and/or a popularity of the merchant (and/or the merchant's promotions and/or products). This merchant registration data can be used to create a merchant profile for the merchant. In some cases, the merchant's profile might also include data about the popularity of the merchant, its products, and/or its promotions (as measured, by example, by consumer ratings as described above, by consumer acceptance of the merchant's promotions, etc.), which might be derived from consumer usage of the promotional systems described herein.

This merchant data (e.g., a merchant profile) can be stored (e.g., in a database, such as the promotions database described above, and/or in a separate database) (block 2710). In an aspect, a plurality of sets of merchant data (e.g., a plurality of merchant profiles), each pertaining to a different merchant, may be created and/or stored in this fashion.

In some cases, the computer user interface might include a mechanism for the user to indicate the interest of the first merchant in participating in cross-promotions (block 2720). Merely by way of example, if the computer system provides a user interface screen for a merchant to register to participate in a promotional program (as described above), that screen might include a user interface element (such as a checkbox, etc.) to allow the user to indicate that the merchant being registered is interested in participating in cross-promotions. Similar mechanisms may be provided at other points in the workflow; for instance, when a merchant creates or edits a promotion (for example, by creating or editing a promotional offer record, as described above), the promotional offer record creation and/or editing screens might provide a user interface element for the merchant to indicate that the merchant is interested in participating in a cross-promotion, perhaps in relation to the promotional offer being created/edited (and/or the product(s) that are the subject of that promotional offer). As can be seen from these examples, a merchant might have the option to indicate a general interest in participating in cross-promotions and/or might have the option to indicate a specific interest in participating in cross-promotions that relate to specific promotions and/or products offered by that merchant.

The method 2700 thus may further comprise receiving (e.g., via the user interface) an indication of the merchant's interest in participating in cross-promotional programs (block 2725). If the merchant indicates interest in participating in cross-promotional programs, that information may be stored by the computer system (e.g., in a field in the merchant's profile) (block 2730). This stored information can be used (as described in further detail below) to identify the merchant as a possible cross-promotion partner for other merchants.

In a set of embodiments, the computer system includes a facility (perhaps provided by the computer user interface) to allow a merchant to initiate a cross-promotion. Typically, to participate in a cross-promotion, a merchant will need to identify the terms of the promotion and identify a promotional partner. The facility provided by the computer system can assist in both of these tasks.

Merely by way of example, the method 2700, in some embodiments, comprises identifying a potential cross-promotion partner for the merchant (block 2735). Any of a variety of techniques can be used to identify a potential cross-promotion partner. Merely by way of example, in some cases, the computer system might simply list for the user all merchants that have indicated an interest in participating in cross-promotions (e.g., by searching a merchant database for profiles of merchants that have indicated such an interest as described above) and allowing the user to select one or more potential partners from this list.

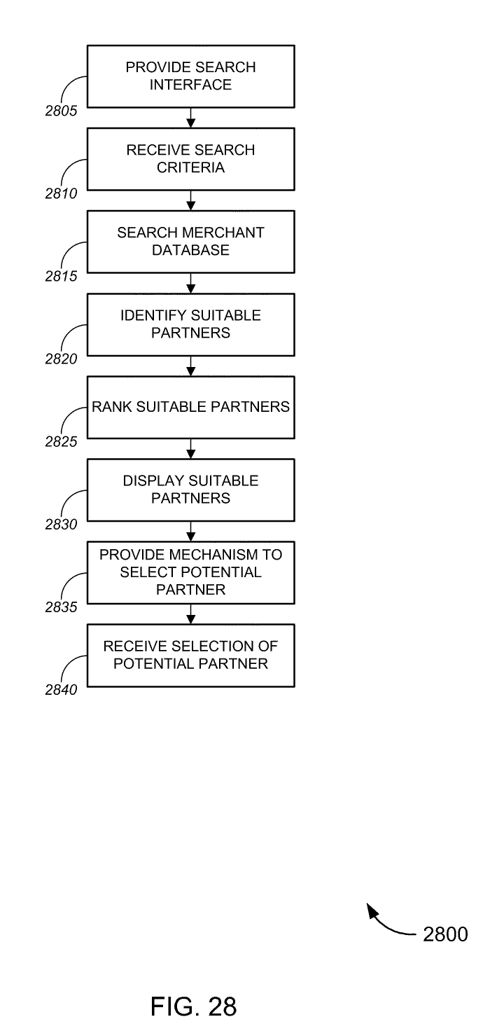

In other cases, however, more sophisticated procedures may be employed. FIG. 28 illustrates a method 2800 that comprises a few such procedures. Merely by way of example, in some cases, the merchant may be provided with the ability to search for possible cross-promotion partners. Accordingly, in some cases, the computer system may provide a search interface that includes a mechanism for the user to provide one or more search criteria for desired cross-promotion partners (block 2805). The search interface may include, in an embodiment, a web-based form comprising user interface elements (text input fields, checkboxes, menus, etc.) that allow the user to specify the desired criteria. In an aspect, the criteria provide to the user might correspond to any of the various types of data stored in the merchant profiles described above. The method 2800, then, might comprise receiving the search criteria specified by the user (block 2810), e.g., via the user interface, and/or searching merchant data (e.g., a set of merchant profiles stored in a database as described above) to identify one or more merchants that satisfy the search criteria (block 2185) as being suitable cross-promotion partners for the merchant. seeking a cross-promotion partner.

In other cases, the computer system might identify suitable cross-promotion partners based on historical data about consumer behavior. Merely by way of example, the computer system might review information about consumer acceptance of various promotional offers from various merchants to identify merchants with a relatively high number of consumers in common with the merchant seeking a cross-promotion partner. Alternatively and/or additionally, the computer system might search for merchants with high overall redemption rates, which would indicate that these merchants have had success in the past with their promotional offers and therefore would make suitable cross-promotion partners.

In some embodiments, once a set of suitable cross-promotion partners have been identified (block 2820) (by any appropriate procedures, including without limitation those described above), the method 2800 might further comprise ranking each of the identified suitable cross-promotion partners (block 2825). A variety of factors may be used to rank the identified partners. In some cases, for instance, data about consumer behavior may be used to rank the identified partners. This ranking might consider factors similar to those described above with respect to identification of suitable partners. Merely by way of example, the computer might rank possible partners in order of their historical success in obtaining consumer redemptions on their promotional offers. As another example, the computer might rank possible partners based on the compatibility of their products/promotional offers with those of the merchant seeking a partner (based, for example, on a common base of consumers that purchase the respective products of the merchant and the possible partner). As yet another example, the computer might rank possible partners based on the proximity of those partners' locations to the location(s) of the merchant seeking a partner. In some cases, a ranking algorithm might take multiple factors (including without limitation those listed above) into account in ranking a plurality of identified possible cross-promotion partners for the merchant.

In some embodiments, the method 2800 further comprises displaying a list of the suitable cross-promotion partners (block 2830), e.g., using the computer user interface. In some cases, this list may be ordered according to the rankings assigned to each of the possible partners. In other cases, the merchant may be provided with a mechanism to request the display of additional information about one or more of the possible partners (including, merely by way of example, information from one or more of the potential partners' merchant profiles). Further, the method 2800 might include providing in the computer user interface a mechanism for the user to select one or more of the suitable cross-promotion partners as a potential cross-promotion partner for the merchant seeking such a partner (block 2825). A variety of such mechanisms are possible. Merely by way of example, in some cases, the displayed list might list each of the suitable partners as a hyperlink, any of which the user can select (click on) to select a potential partner. In another embodiment, each entry on the list might be accompanied by a checkbox, radio button, etc., which the user can activate to select one or more potential partners. The method 2800, then, can include receiving the user's selection of one or more potential cross-promotion partners from the list (block 2840).

Returning to FIG. 27, once a potential cross-promotion partner for the merchant has been identified, the method 2700 comprises providing, in the computer user interface, a mechanism for the user to define a proposed cross-promotion with the potential cross-promotion partner (block 2740). In an embodiment, this mechanism might involve procedures similar to those used to define a promotion by creating a promotional offer record, described above with respect to FIG. 19. In many cases, however, a cross-promotion includes a promotional offer pertaining not just to a product of the merchant, but also to a product (or multiple products) of the merchant's cross-promotion partner. Hence, the mechanism for defining a proposed cross-promotion might comprise user input facilities to allow the user to define (or suggest and/or request) the portion of the cross-promotion provided by the merchant's potential cross-promotion partner. (Alternatively, the definition of this portion of the cross-promotion could be left to the partner, as described below).

The method 2700 might further comprise receiving, from the user (e.g., via the user interface) information defining a proposed cross-promotion (block 2745). This information can include, without limitation, any or all of the following information: an identification of a potential cross-promotion partner, terms of the portion of the cross-promotion that relates to the merchant's products (e.g., a certain discount on a certain product), terms of the portion of the cross-promotion that relates to the potential cross-promotion partner's product (e.g., you must buy a certain product from the potential partner to receive the discount on the merchant's product), and/or any terms between the merchant and the potential partner (e.g., for each redemption, the potential partner will reimburse the merchant for half of the discount on the merchant's products). A variety of different cross-promotions (and/or terms between the merchant and the potential partner) can be supported in accordance with various embodiments; hence, the examples herein are provided for illustrative purposes, and should not be considered limiting.

Certain embodiments also support communication between the merchant and the merchant's potential cross-promotion partner, including without limitation providing notification of the proposed cross-promotion to the potential cross-promotion partner. In some cases, this notification may be sent automatically, without any input from the merchant proposing the cross-promotion. In other cases, however, the merchant may be given the opportunity to initiate communication with the potential partner. Hence, in some embodiments, the method 2700 comprises providing a communication interface for communication between the merchant and the merchant's potential cross-promotion partner (block 2750). In some cases, this communication interface might take the form of a hyperlink (or other mechanism) that allows the merchant to send a communication, such as an email message, directly to the potential partner. In other cases, the communication interface might simply comprise a mechanism (such as a button on a web page, etc.) with which the merchant can request that the computer system provide the potential partner with a notification about the proposed cross-promotion. In yet other cases, the communication interface might comprise a mechanism (such as a text input field and/or the like), by which the merchant can provide comments to be provided to the potential partner.

Hence, the method 2700, in some embodiments, comprises receiving at the computer system (e.g., via the computer user interface and, more specifically, any of the mechanisms described above) user input from the merchant requesting that the potential partner be notified of the proposed cross promotion (block 2755). The computer system, in response to the request to provide notification, notifies the potential partner of the proposed cross-promotion. There are variety of techniques by which this notification may be made. In some cases, for example, the computer system might send an email message to an address in the potential partner's merchant profile.

Alternatively and/or additionally, the computer system might provide the notification (perhaps including detailed information about the proposed cross-promotion) the next time the potential partner logs into the computer system. Hence, in an embodiment, the method 2700 comprises providing a computer user interface for interacting with a second user associated with the potential cross-promotion partner (block 2760). Techniques for providing this computer user interface are similar to those described above. In particular, however, this second computer user interface may be used by the computer system to display, for the potential cross-promotion partner, the notification about the proposed cross promotion (block 2765). In an aspect, this information can include any or all of the information about the proposed cross-promotion received from the merchant proposing the cross-promotion. Additionally and/or alternatively, the information displayed for the potential partner may include information from the merchant's profile, including without limitation an identification of the merchant proposing the cross-promotion, information about that merchant's products and/or promotions, information about that merchant's location, popularity, and/or the like. In some aspects, the merchant proposing the cross-promotion may have the option to specify how much of its profile information should displayed for the potential cross-promotion partner.

The method 2700, in certain embodiments, further comprises providing, in the user interface, a mechanism for the potential partner to provide feedback on the proposed cross-promotion (block 2770). In a typical case, this mechanism is provided along with the display of the proposed cross-promotions, and the mechanism can vary according to different embodiments. Merely by way of example, in some cases, the mechanism might merely comprise a hyperlink (or similar device) to allow the potential partner to send an email message directly to the merchant. In other cases, the mechanism might comprise a text input field into which the proposed partner can type its feedback. In other cases, the user interface might display the information about the proposed cross-promotion in such a way as to allow the potential partner to edit each of the terms and/or counter-propose different terms for one or more of the terms (e.g., the merchant's product(s), the potential partner's product(s), the amount of discount, any reimbursement terms, etc.). An example might include a list of the terms of the proposed cross-promotion, along with a text input field corresponding to each of the terms of the proposal (each of which might be pre-populated with the terms of the proposal, to allow for easy editing by the proposed partner). In some cases, the feedback mechanism might include a device (such as a button on a web site) for the potential partner to indicate acceptance of the proposal, and/or a similar device for the potential partner to indicate that it is not interested in any cross-promotion with the proposing merchant. As can be seen from these examples, there are a variety of mechanisms that can be employed to allow the potential partner to provide feedback.

The method 2700, then, might further include receiving such feedback from the potential cross-promotion partner (e.g., as user input provided by the proposed partner via the user interface) (block 2775). If the merchant proposing the cross-promotion did not define a promotional offer for the proposed partner's portion of the cross-promotion, this feedback can include a suggested promotional offer for the proposed partner's portion of the cross-promotion. If the merchant proposing the cross-promotion did define a promotional offer for the proposed partner's portion, the feedback may include suggested revisions to this promotional offer, which might be considered a counterproposal comprising information about a modified cross-promotion. Similarly, if the merchant proposed terms between the merchant and the potential partner, the feedback can include suggested revisions to the promotional offer, while if the merchant did not propose any such terms, the feedback may include such a proposal. Of course, if the potential partner is satisfied with the proposal from the merchant, the feedback might merely comprise an acceptance of the proposal, while if the potential partner is uninterested in any cross-promotion with the merchant proposing the cross-promotion, the feedback might simply decline the proposal.

At block 2780, the computer system displays the feedback (e.g., in a user interface) for the merchant that originally proposed the cross-promotion. This display, in an aspect might be similar to the display of the original proposal to the potential partner (as described above with respect to blocks 2765 and 2770). Accordingly, if the potential partner's feedback included any suggested changes to the proposed cross-promotion, mechanisms similar to those described above may be provided to allow the proposing merchant to respond to this feedback. This feedback process may be performed iteratively (as indicated on FIG. 27 by the broken line between blocks 2780 and 2770) until one of the parties to the proposal has indicated either acceptance of the current state of the proposal or a lack of interest in proceeding further with the proposed cross-promotion.

The method 27000, in an embodiment, further comprises receiving an indication from one of the parties that the parties have agreed on terms of the proposed cross-promotion (block 2785). At this point, a promotional offer record comprising the cross-promotion (including the terms to which the parties agreed) is stored (e.g., in a promotions database, as described above) (block 2790). Thereafter, the promotional offer embodied by the promotional offer record may be displayed to one or more consumers, as described above (block 2795).

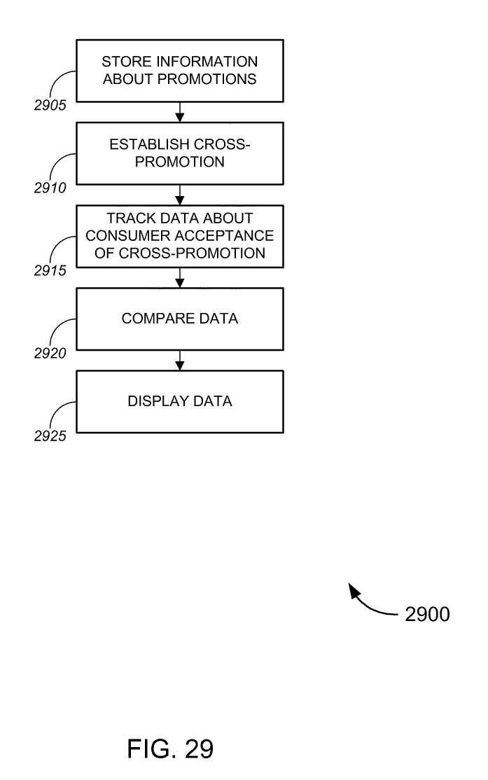

As noted above, certain embodiments provide merchants with the ability to assess the efficiency and/or efficacy of cross-promotions. FIG. 29 illustrates a method 2900 of promoting one or more products, which can include one or more procedures for tracking the effectiveness of such promotions. The method 2900 comprises storing, in a database, information about a plurality of promotions (e.g., a plurality of promotional records, as described above) (block 2905). The method 2900 further comprises establishing a cross-promotion, which might comprises a relationship between a first promotion for a first product and a second promotion for a second product (block 2910). There are many possible techniques for establishing such a cross-promotion. The methods 2700 and 2800 described describe several such techniques, but others are possible as well. In some cases, as noted above, a promotional offer record corresponding to this cross-promotion may be stored in the promotions database. (Typically, there may be a plurality of promotional offer records, some of which relate to normal promotions and some of which relate to cross-promotions. These different types of offer records may be stored in the same database, or they may be stored in different databases.)

In some embodiments, the method 2900 further comprises tracking data about consumer acceptance of the cross-promotion (block 2915). Such data can include, inter alia, consumer intelligence data (some of which is described above), such as data about consumer redemptions of the cross-promotion (such as redemption rates, which can be a relative number of promotional offers redeemed as a fraction of the overall number of offers distributed to consumers, an absolute number of redemptions across various time periods, etc.), data about a product sales resulting from the cross-promotion (such as a number of products sold, an amount of revenue generated by the products sold and/or attributable to the cross-promotion, etc.).

In some cases, a merchant will be interested in comparing the cross-promotion (or any promotion, for that matter) with other promotions offered by that merchant or another. Hence, the method 2900 may comprise comparing a particular cross-promotion (or, more generally, promotion) with one or more other cross-promotions (or promotions) (block 2920). Any of the consumer acceptance data may be used for such a comparison; in some cases, the merchant may be given the option of selecting the type(s) of data to compare. Hence, in an embodiment, the data about consumer acceptance of a promotion might be comparative data that compares a particular promotion with one or more other promotions. In this way, the merchant can gain insight into the relative effectiveness of the cross-promotion. In a particular embodiment, for example, the comparative data might compare consumer acceptance of a cross-promotion of a particular product with consumer acceptance of another promotion (which may be, but need not be, a cross-promotion) of the same product, to provide the merchant with an apples-to-apples comparison to allow the merchant to determine whether the cross-promotion is a more effective way of marketing that product (and/or the merchant's products in general).

The method 2900 further comprises, in some embodiments, displaying (e.g., in the computer user interface), the data (which may be, but need not be, comparative data) about consumer acceptance of the promotion (block 2925). A variety of formats may be used to display this data; examples include plots of historical data (perhaps plotting two data sets, one for the cross-promotion and one for another promotion) about consumer acceptance (e.g., redemption rates, overall redemptions, sales, etc.), pie charts showing relative redemption rates, tables (which might have multiple columns to provide a side-by-side comparison of the cross-promotion with another promotion) displaying various data about consumer acceptance, and/or the like.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of allowing consumers to participate selectively in promotional programs, the method comprising:
receiving, from a first consumer, an indication that the first consumer is interested in participating in a promotional discount program;
receiving, from the first consumer, identification of one or more types of products about which the first consumer is interested in receiving promotional discounts;
storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional discounts;
storing, in a second data store, data about a plurality of promotional discounts, including a first promotional discount that is redeemable against a price of a first product;
searching the second data store to identify, from the plurality of promotional discounts, one or more promotional discounts to be offered to the first consumer, based on the identification of one or more types of products about which the first consumer is interested in receiving promotional discounts;
determining, at a computer in communication with the first data store and the second data store, that the first product is the type of product for which the first consumer desires to receive promotional discounts;
associating, at the computer, the first promotional discount with the first consumer profile, based on a determination that the first product is the type of product for which the first consumer desires to receive promotional discounts; and
notifying the first consumer of the availability of the promotional discount to the first consumer.

2. A computer system for allowing consumers to participate selectively in promotional programs, the computer system comprising:
a processor; and
a computer readable medium in communication with the processor, the computer readable medium having encoded thereon a set of instructions that are executable by the computer system to perform one or more operations, the set of instructions comprising:
instructions for receiving, from a first consumer, an indication that the first consumer is interested in participating in a promotional discount program;
instructions for receiving, from the first consumer, identification of one or more types of products about which the first consumer is interested in receiving promotional discounts;
instructions for storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional discounts;
instructions for storing, in a second data store, data about a plurality of promotional discounts, including a first promotional discount that is redeemable against a price of a first product;
instructions for searching the second data store to identify, from the plurality of promotional discounts, one or more promotional discounts to be offered to the first consumer, based on the identification of one or more types of products about which the first consumer is interested in receiving promotional discounts;
instructions for determining, at a computer in communication with the first data store and the second data store, that the first product is the type of product for which the first consumer desires to receive promotional discounts;
instructions for associating, at the computer, the first promotional discount with the first consumer profile, based on a determination that the first product is the type of product for which the first consumer desires to receive promotional discounts; and
instructions for notifying the first consumer of the availability of the promotional discount to the first consumer.

3. An apparatus, comprising:
a computer readable medium having encoded thereon a set of instructions that are executable by a computer system to perform one or more operations, the set of instructions comprising:
instructions for receiving, from a first consumer, an indication that the first consumer is interested in participating in a promotional discount program;
instructions for receiving, from the first consumer, identification of one or more types of products about which the first consumer is interested in receiving promotional discounts;
instructions for storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional discounts;
instructions for storing, in a second data store, data about a plurality of promotional discounts, including a first promotional discount that is redeemable against a price of a first product;
instructions for searching the second data store to identify, from the plurality of promotional discounts, one or more promotional discounts to be offered to the first consumer, based on the identification of one or more types of products about which the first consumer is interested in receiving promotional discounts;
instructions for determining, at a computer in communication with the first data store and the second data store, that the first product is the type of product for which the first consumer desires to receive promotional discounts;
instructions for associating, at the computer, the first promotional discount with the first consumer profile, based on a determination that the first product is the type of product for which the first consumer desires to receive promotional discounts; and
instructions for notifying the first consumer of the availability of the promotional discount to the first consumer.

4. A method of allowing consumers to participate selectively in promotional programs, the method comprising:
receiving, at a computer system and from a first consumer, an indication that the first consumer is interested in participating in a promotional discount program;
receiving, from the first consumer, identification of one or more types of products about which the first consumer is interested in receiving promotional discounts;
associating, at the computer system, a first promotional discount with the first consumer profile, based on a determination that first promotional discount applies to a first product that is the type of product for which the first consumer desires to receive promotional discounts;
notifying the first consumer of the availability of the promotional discount;
receiving, at the computer system, a set of transaction data for a first transaction, the set of transaction data comprising the consumer identifier and a product identifier for the first product;
determining, based on receipt of the consumer identifier and an association between the first consumer profile and the first promotional discount, that the first consumer is eligible for the first promotional discount;
applying the first promotional discount against the price of the first product, based on a determination that the first consumer is eligible for the first promotional discount.

5. A computer system for allowing consumers to participate selectively in promotional programs, the computer system comprising:
a processor; and
a computer readable medium in communication with the processor, the computer readable medium having encoded thereon a set of instructions that are executable by the computer system to perform one or more operations, the set of instructions comprising:
instructions for receiving, from a first consumer, an indication that the first consumer is interested in participating in a promotional discount program;
instructions for receiving, from the first consumer, identification of one or more types of products about which the first consumer is interested in receiving promotional discounts;
instructions for associating a first promotional discount with the first consumer profile, based on a determination that first promotional discount applies to a first product that is the type of product for which the first consumer desires to receive promotional discounts;
instructions for notifying the first consumer of the availability of the promotional discount;
instructions for receiving a set of transaction data for a first transaction, the set of transaction data comprising the consumer identifier and a product identifier for the first product;
instructions for determining, based on receipt of the consumer identifier and an association between the first consumer profile and the first promotional discount, that the first consumer is eligible for the first promotional discount;
instructions for applying the first promotional discount against the price of the first product, based on a determination that the first consumer is eligible for the first promotional discount.

6. An apparatus, comprising:
a computer readable medium having encoded thereon a set of instructions that are executable by a computer system to perform one or more operations, the set of instructions comprising:
instructions for receiving, from a first consumer, an indication that the first consumer is interested in participating in a promotional discount program;
instructions for receiving, from the first consumer, identification of one or more types of products about which the first consumer is interested in receiving promotional discounts;
instructions for associating a first promotional discount with the first consumer profile, based on a determination that first promotional discount applies to a first product that is the type of product for which the first consumer desires to receive promotional discounts;
instructions for notifying the first consumer of the availability of the promotional discount;
instructions for receiving a set of transaction data for a first transaction, the set of transaction data comprising the consumer identifier and a product identifier for the first product;
instructions for determining, based on receipt of the consumer identifier and an association between the first consumer profile and the first promotional discount, that the first consumer is eligible for the first promotional discount;
instructions for applying the first promotional discount against the price of the first product, based on a determination that the first consumer is eligible for the first promotional discount.

7. A method of allowing consumers to participate selectively in promotional programs, the method comprising:
receiving, from a first consumer, an indication that the first consumer is interested in participating in a promotional program;
receiving, from the first consumer, identification of one or more types of products about which the first consumer is interested in receiving promotional information;
storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional information;
storing, in a second data store, data about a plurality of sets of promotional information, including a first set of promotional information;
searching the second data store to identify, from the plurality of sets of promotional information, a first set of promotional information to be offered to the first consumer, based on the identification of one or more types of products about which the first consumer is interested in receiving promotional information;
determining, at a computer in communication with the first data store and the second data store, that the first consumer would like to receive the first set of promotional information; and
providing the first set of promotional information to the first consumer.

8. A computer system for allowing consumers to participate selectively in promotional programs, the computer system comprising:
a processor; and
a computer readable medium in communication with the processor, the computer readable medium having encoded thereon a set of instructions that are executable by the computer system to perform one or more operations, the set of instructions comprising:
instructions for receiving, from a first consumer, an indication that the first consumer is interested in participating in a promotional program;
instructions for receiving, from the first consumer, identification of one or more types of products about which the first consumer is interested in receiving promotional information;
instructions for storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional information;
instructions for storing, in a second data store, data about a plurality of sets of promotional information, including a first set of promotional information;
instructions for searching the second data store to identify, from the plurality of sets of promotional information, a first set of promotional information to be offered to the first consumer, based on the identification of one or more types of products about which the first consumer is interested in receiving promotional information;
instructions for determining that the first consumer would like to receive the first set of promotional information; and
instructions for providing the first set of promotional information to the first consumer.

9. An apparatus, comprising:
a computer readable medium having encoded thereon a set of instructions that are executable by a computer system to perform one or more operations, the set of instructions comprising:
instructions for receiving, from a first consumer, an indication that the first consumer is interested in participating in a promotional program;
instructions for receiving, from the first consumer, identification of one or more types of products about which the first consumer is interested in receiving promotional information;
instructions for storing, in a first data store, data about a plurality of consumers, the information comprising consumer profiles for a plurality of consumers, including a first consumer profile for the first consumer, the first profile comprising a consumer identifier for the first consumer and a set of preferences for the first consumer, the set of preferences comprising information about a type of product for which the first consumer desires to receive promotional information;
instructions for storing, in a second data store, data about a plurality of sets of promotional information, including a first set of promotional information;
instructions for searching the second data store to identify, from the plurality of sets of promotional information, a first set of promotional information to be offered to the first consumer, based on the identification of one or more types of products about which the first consumer is interested in receiving promotional information;
instructions for determining that the first consumer would like to receive the first set of promotional information; and
instructions for providing the first set of promotional information to the first consumer.
